(19) United States
(12) Patent Application Publication
(10) Pub. No.: US 2008/0229196 A1
(43) Pub. Date: Sep. 18, 2008

(54) IMAGE FORMING APPARATUS

(76) Inventor: Hideaki Yamagata, Kanagawa (JP)

Correspondence Address: DICKSTEIN SHAPIRO LLP, 1825 EYE STREET NW, Washington, DC, 20006-5403, US

(21) Appl. No.: 12/048,706

(22) Filed: Mar. 14, 2008

(30) Foreign Application Priority Data
Mar. 15, 2007 (JP) 2007-067446

(51) Int. Cl. G06F 3/048

(52) U.S. Cl. 715/705

(57) ABSTRACT

An image forming apparatus can display a hint screen or a help screen on a display unit to explain the way of operation to be executed by the apparatus. A hint controlling unit generates a HTML file of the hint screen corresponds to each screen based on weighting of each manual upon calculation of weight of each manual. A screen controlling unit displays manuals in the order of weighting based on the HTML file generated in the hint controlling unit while the character size is varied depending on the weighting to display. This allows a user to easily select a manual that is more likely to contain information that the user want to refer.

### CROSS-REFERENCE TO RELATED APPLICATIONS

The present application claims priority to and incorporates by reference the entire contents of Japanese priority document 2007-067446 filed in Japan on Mar. 15, 2007.

### BACKGROUND OF THE INVENTION

1. Field of the Invention

The present invention relates to an image forming apparatus that facilitates searching of an operation manual.

2. Description of the Related Art

In recent years, a complex machine which is so called Multi Function Peripheral (MFP) having a plurality of functions including a scanner that reads a document image, a copier that prints a document image read by the scanner, a printer that prints image data input from external, and a facsimile device that sends a document image read by the scanner to an external device is used.

In such a complex machine, complicated operation associated with multifunctionalization of the machine has raised the necessity of manual and help (help screen) that explain the way of operation. However, as a machine is multifunctionalized, manual and help have more complicated description and increased volume. Therefore, means is taken to improve user convenience by electronization of the manual and resulting improvement in search performance. Also as a machine is multifunctionalized, utilization and development of an operation panel for operating such machine have advanced, and an operation screen is further complicated and hierarchized.

Under such a circumstance, the necessity of help screen, guide and the like (hereinafter, “hint”) for providing a manual for an operation screen is increased. Further, as the size of screen of operation panel is increased, detailed hint can be displayed on the operation screen. This also contributes to improve the operability.

Here, when the number of linked manuals for one hint is small, a user can readily select a desired manual and display it. However, the higher the hierarchy of the operation screen, the more then number of related manuals. Therefore a technique is needed that allows a user to reach an appropriate manual that the user is looking for in short time.

As a technique for selectively displaying an appropriate manual, Japanese Patent No. 2645027 and Japanese Examined Patent Publication No. 7-85212 propose a method involving asking a user of an appropriate question, and narrowing down the manuals based on an answer to the question.

However, in the methods proposed in Japanese Patent No. 2645027 publication and Japanese Examined Patent Publication No. 7-85212, as the items and volume of the manual increase as a result of multifunctionalization, it becomes difficult to input a question appropriate for the narrowing down, and the number of question items increases. Further, it is inconvenient for a user to generate a question by inputting characters in an image forming apparatus not having an input device such as keyboard through which characters can be readily input.

### SUMMARY OF THE INVENTION

It is an object of the present invention to at least partially solve the problems in the conventional technology.

According to an aspect of the present invention, an image forming apparatus includes an operation data storing unit that stores relation between a screen displayed on a displaying unit and a plurality of manuals referable from the screen displayed on the displaying unit, a manual data storing unit that stores relation between the manual and operation of the image forming apparatus, an accumulating unit that, when a plurality of screens are displayed sequentially on the displaying unit according to an instruction from a user, and a predetermined operation is executed by the image forming apparatus, accumulates the plurality of the displayed screens in correspondence with the executed operation, a display instruction receiving unit that receives display instruction of the manual from the user, a manual designating unit that, when the display instruction receiving unit receives the display instruction from the user, designates the plurality of manuals correlated with the screen displayed on the displaying unit in accordance with the relation stored in the operation data storing unit, an operation designating unit that designates the operation associated with each of the plural manuals designated by the manual designating unit in accordance with the relation stored in the manual data storing unit, a weighting unit that gives weight to each of the plural manuals designated by the manual designating unit, according to an operation that corresponds to each operation designated by the operation designating unit and is accumulated in the accumulating unit, and a hint screen generating unit that generates a hint screen in which display of link to each of the plural manuals is varied based on the weight given by the weighting unit.

According to another aspect of the present invention, an image forming apparatus includes an operation data storing unit that stores relation between a screen displayed on a displaying unit and a plurality of manuals referable from the screen displayed on the displaying unit, an accumulating unit that, when a screen is displayed on the displaying unit according to an instruction from a user, and a manual is referred, accumulates the displayed screen in correspondence with the referred manual, a display instruction receiving unit that receives display instruction of the manual from the user, a manual designating unit that, when the display instruction receiving unit receives the display instruction from the user, designates the plurality of manuals correlated with the screen displayed on the displaying unit in accordance with the relation stored in the operation data storing unit, a weighting unit that gives weight to each of the plural manuals designated by the manual designating unit, according to the number of times that the plural manuals designated by the manual designating unit are referred in the accumulating unit, and a hint screen generating unit that generates a hint screen in which display of link to each of the plural manuals is varied based on the weight given by the weighting unit.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a view of a functional configuration of an image forming apparatus according to an embodiment of the present invention;

FIG. 2 is a view of a tree structure representing relationship among screen, hint screen and manual;

FIG. 3 is a correspondence table of a command and a sending destination of the command, in correspondence with a button ID;

FIG. 4 is a view of relation between manual and operation associated with the manual;

FIG. 5 is a view of an example of a log that stores screen transition history and executed operation in correlation with each other;

FIG. 6 is a flowchart of basic operation of an apparatus controlling unit;

FIG. 7 is a flowchart of basic operation of a screen controlling unit;

FIG. 8 is a flowchart of basic operation of a hint controlling unit;

FIG. 9 is a flowchart of basic operation of an operation detecting unit;

FIG. 10 is a flowchart of a process of calculating weight of each manual;

FIG. 11 is a view of an example of a copy initial setting screen;

FIG. 12 is a view of lastly executed operation and calculation result of link number of manual;

FIG. 13 is a view of an example of hint screen displayed based on weighting result;

FIG. 14 is a view of lastly executed operation and calculation result of link number of manual;

FIG. 15 is a view of an example of hint screen displayed based on weighting result;

FIG. 16 is a flowchart of a process of calculating weight of each manual;

FIG. 17 is a view of an example of storing each manual and operation associated with each manual in correspondence with each other;

FIGS. 18A and 18B are views of degree of relevance between executed operation and each manual, and result of addition of degree of relevance between executed operation and each manual for each manual;

FIG. 19 is a flowchart of a process of calculating weight of each manual;

FIG. 20 is a view of an example in which relation between option attached to and detached from image forming apparatus and manual, and degree of relevance thereof are stored in correspondence with each other;

FIG. 21 is a view of result of addition of weight of associated option to each manual;

FIG. 22 is a view of a functional configuration of an image forming apparatus according to an embodiment of the present invention;

FIG. 23 is a view of an example of log in which screen transition history and reference history of manual are stored in correlation with each other;

FIG. 24 is a flowchart of basic operation of a hint controlling unit;

FIG. 25 is a flowchart of a process of calculating weight of each manual;

FIG. 26 is a view of calculated result of referred number of times of each manual;

FIG. 27 is a view of an example of hint screen displayed based on weighting result;

FIG. 28 is a view of calculated result of referred number of times of each manual;

FIG. 29 is a view of an example of hint screen displayed based on weighting result;

FIG. 30 is a view of a tree structure representing relation between screen, hint screen and manual;

FIG. 31 is a flowchart of a process of calculating weight of each manual;

FIG. 32 is a view of an example of hint screen displayed based on weighting result;

FIG. 33 is a view of a schematic configuration of an image forming apparatus;

FIG. 34 is a view of a schematic configuration of a print system;

FIG. 35 is a view of a schematic configuration of a personal computer;

FIG. 36 is a view of a functional configuration of a personal computer;

FIG. 37 is a view of an example of copy initial setting screen;

FIG. 38 is a view of an example of hint screen; and

FIG. 39 is a view of a display example of copy screen.

### DETAILED DESCRIPTION OF THE PREFERRED EMBODIMENTS

In the following, exemplary embodiments of an image forming apparatus according to the present invention will be explained in detail, with reference to attached drawings.

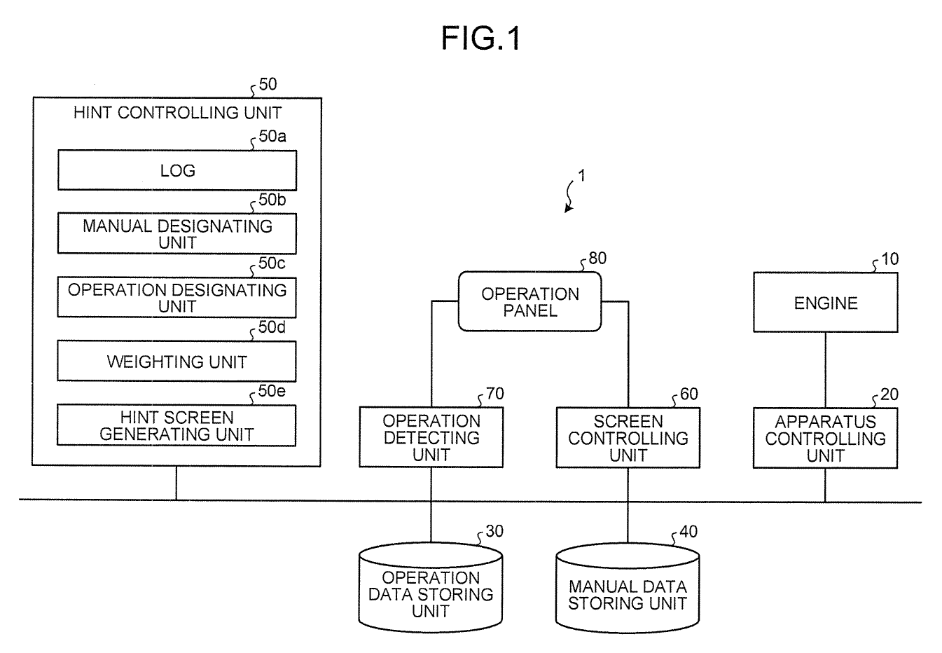

FIG. 1 is a block diagram of a functional configuration of an image forming apparatus according to the present embodiment. An image forming apparatus according to the present embodiment includes an engine 10, an apparatus controlling unit 20, an operation data storing unit 30, a manual data storing unit 40, a hint controlling unit 50, a screen controlling unit 60, an operation detecting unit 70, and an operation panel (touch panel) 80.

The engine 10 is a main part of the image forming apparatus according to the present invention, and includes, for example, a scanner, a printer, an ADF.

The operation panel 80 is a touch panel which displays a screen input from the screen controlling unit 60, receives a user operation on the screen, and informs the operation detecting unit 70 of a signal representing the received operation. In the present embodiment, a displaying unit and an operating unit are realized by a combination of a display and an input device by using a touch panel as the operation panel 80, however, the displaying unit and the operating unit may be configured by different hardware.

The operation detecting unit 70 analyzes a signal transmitted from the operation panel 80 to detect that a button was pressed down by a user, determines ID of the pressed down button, reads out a command corresponding the button ID with reference to a correspondence table as will be described later, and a sending destination of the command, and sends the command to the sending destination.

The screen controlling unit 60 acquires a screen from the operation data storing unit 30 according to a command indicating display of screen from the operation detecting unit 70, and displays the screen in the operation panel 80. The screen controlling unit 60 has a browser function of acquiring a HTML (Hyper Text Markup Language) file concerning a manual from the manual data storing unit 40, analyzing the layout, and displaying a screen. Further, the screen controlling unit 60 has a browser function of acquiring a HTML file concerning hint screen generated in the hint controlling unit 50 as will be described later, analyzing the layout, and displaying the hint screen. In the present embodiment, the manual and the hint screen are managed or generated in HTML format.

The apparatus controlling unit 20 controls operation in the engine 10 in response to a command from the operation detecting unit 70. Upon completion of operation in the engine 10, the apparatus controlling unit 20 sends data regarding executed operation (hereinafter, “operation data”) to the operation detecting unit 70.

For example, upon reception of a command of “copy” from the operation detecting unit 70, the apparatus controlling unit 20 starts up the engine 10 based on a stored parameter concerning operation to read a document on a contact glass, and prints the read image on paper. After completion of printing operation, the apparatus controlling unit 20 sends operation data to the hint controlling unit 50.

Commands received by the apparatus controlling unit 20 are not limited to commands for operating the engine 10. For example, when “combine” command is sent from the operation detecting unit 70, the information that combining is currently designated is stored as a parameter, and the process ends without operating the engine 10.

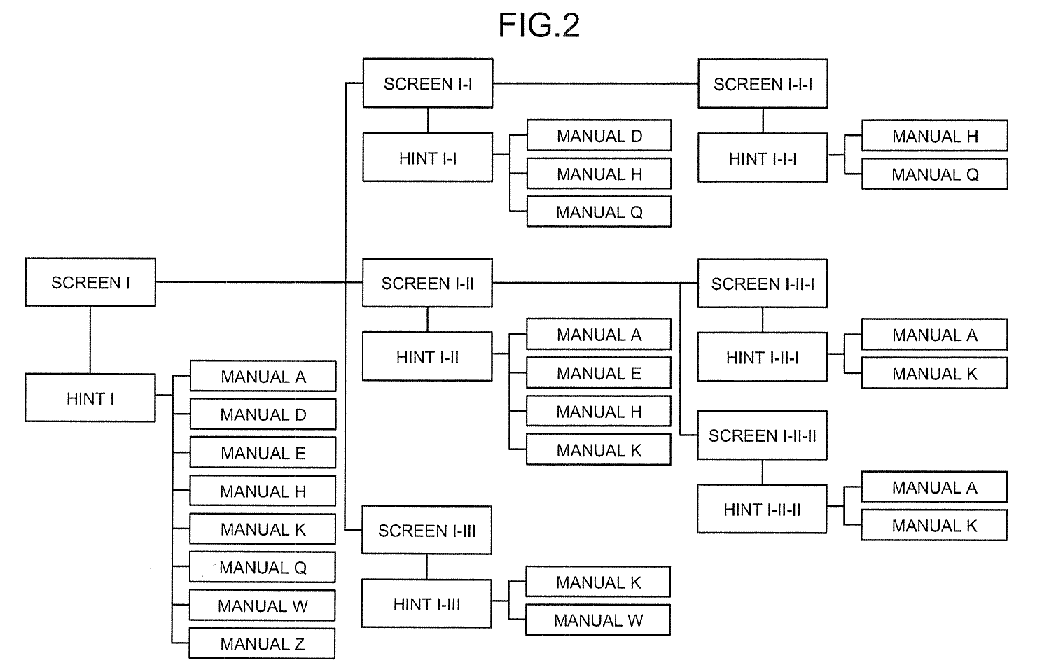

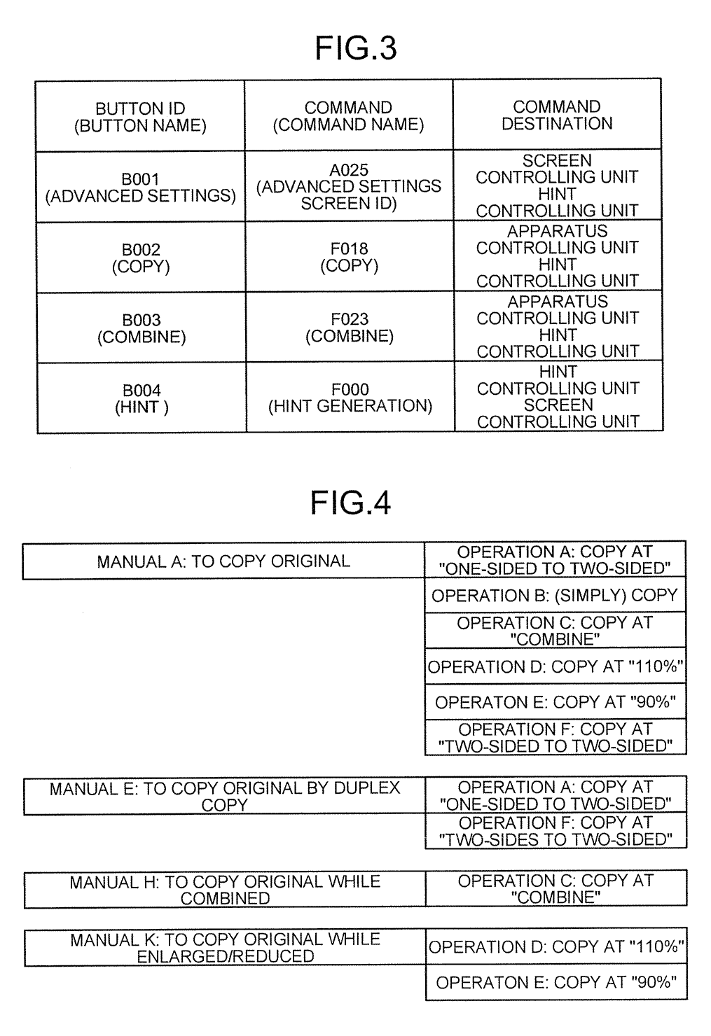

As depicted in FIG. 2, the operation data storing unit 30 stores screens displayed on the operation panel 80 in the order that these screens are displayed. For example, from screen I, screen I-I, and screen I-I-I are stored in this order. As a subsequent screen of screen I, screen I-II and screen I-III are stored following screen I-I. The screen to be displayed next to screen I-I among these screens is indicated by a user. Also a hint screen which can be displayed from each screen is stored in correlation with the respective screen. Also a manual which can be displayed from each hint screen is stored in correlation with the respective hint screen. That is, screens stored in the operation data storing unit 30 are stored in correlation with manuals that can be referable via a hint screen corresponding to each screen. Further, as depicted in FIG. 3, the operation data storing unit 30 stores a correspondence table that correlates button ID of button on screen, command corresponding to the button ID, and sending destination of the command.

As depicted in FIG. 4, the manual data storing unit 40 stores data of manual which can be referred from the operation panel 80, and operation concerning the manual in correlation with each other. Data of a manual is also stored in HTML format.

The hint controlling unit includes a log 50a, a manual designating unit 50b, an operation acquiring unit 50c, a weighting unit 50d, and a hint screen generating unit 50e, and generates a hint screen in HTML format based on a command from the operation detecting unit 70, and sends a HTML file concerning the generated hint screen to the screen controlling unit 60.

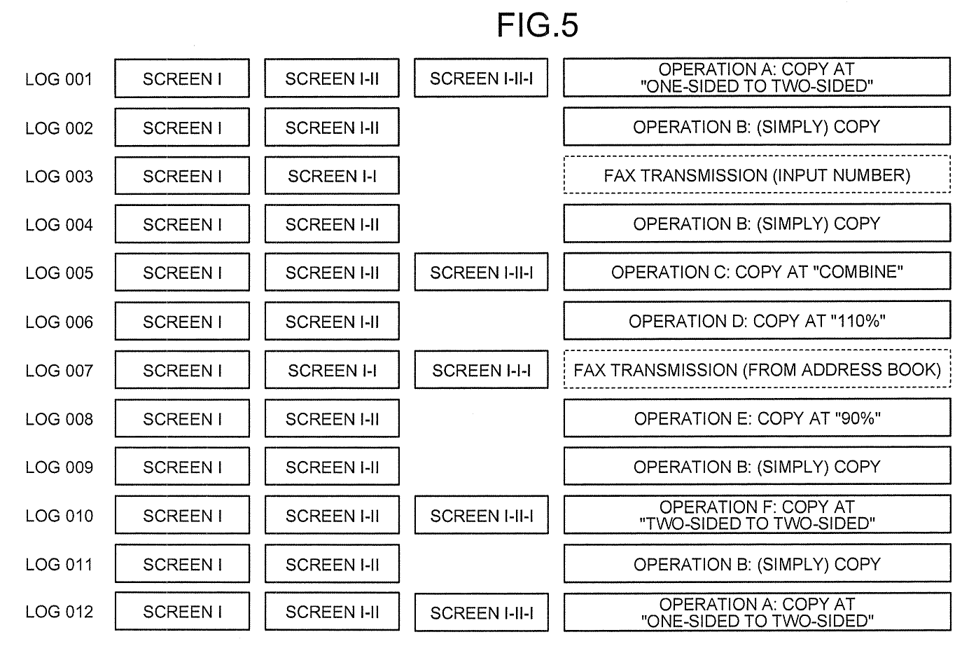

As depicted in FIG. 5, when a plurality of screens are sequentially displayed on the operation panel 80 according to commands from the operation detecting unit 70, and when a predetermined operation is executed in the engine 10, the log 50a accumulates the plural screens and the operation in correlation with each other. The screens that are displayed before the operation is executed are stored in the displayed order.

The manual designating unit 50b designates a plurality of manuals stored in the operation data storing unit 30 in correlation with a screen being displayed in the operation panel 80, when the hint controlling unit 50 receives a command of instructing generation of a hint screen from the operation detecting unit 70.

The operation designating unit 50c designates an operation which is correlated with each of the plural manuals designated by the manual designating unit 50b in the manual data storing unit 40.

The weighting unit 50d gives weight corresponding to an operation accumulated in the log 50 which coincides with each operation designated by the operation designating unit 50c for each of the plural manuals designated by the manual designating unit 50b. The manner of weighting will be described later.

The hint screen generating unit 50e generates a HTML file concerning hint screen in which display state showing link of each manual and order or each manual is varied, based on the weight of each manual to which weight is given by the weighting unit 50d.

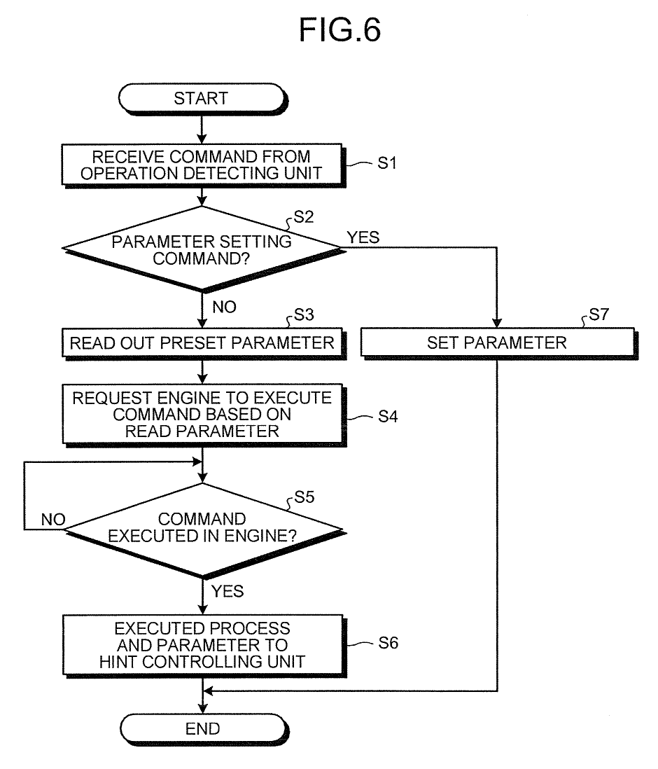

Next, basic operations of the apparatus controlling unit 20, the screen controlling unit 60, the hint controlling unit 50, and the operation detecting unit 70 will be explained in detail by using FIGS. 6 to 9.

FIG. 6 is a flowchart of a process executed by the apparatus controlling unit 20 in response to a command from the operation detecting unit 70. First, the apparatus controlling unit 20 waits for a command from the operation detecting unit 70, and upon reception of a command (Step S1), it identifies whether the command requests to change setting of parameter (Step S2).

When the command sent from the operation detecting unit 70 does not request to change setting of parameter, but requests a process in the engine 10 (Step S2/No), the apparatus controlling unit 20 reads out a predetermined parameter (Step S3), and requests the engine 10 to execute the command based on the read out parameter (Step S4).

When the command sent from the operation detecting unit 70 requests to change setting of parameter (Step S2/Yes), the apparatus controlling unit 20 changes setting of parameter based on the command (Step S7).

The engine 10 executes an image forming process corresponding to the command sent from the operation detecting unit 70 based on the parameter set in the apparatus controlling unit 20, and notifies the apparatus controlling unit 20 that execution of the process has completed (Step S5/Yes). Upon reception of the notification that execution has completed from the engine 10, the apparatus controlling unit 20 sends operation data to the hint controlling unit 50 (Step S6).

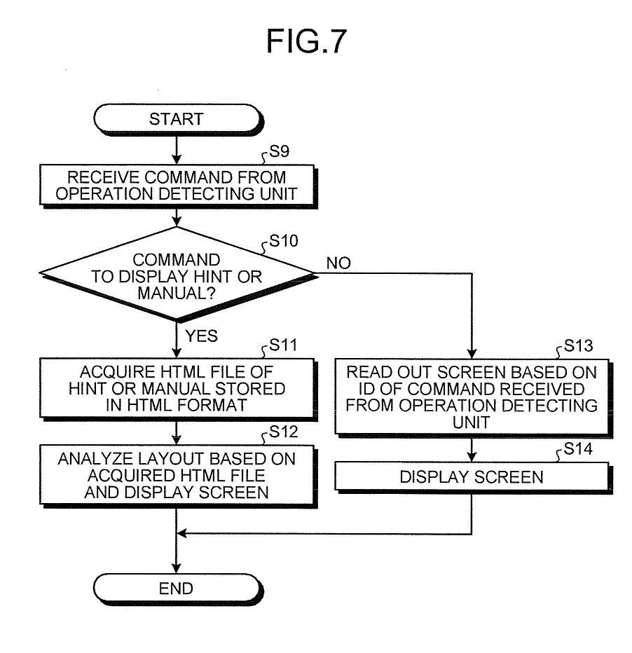

FIG. 7 is a flow chart of a process executed by the screen controlling unit 60 upon reception of a command from the operation detecting unit 70. The screen controlling unit 60 first waits for a command from the operation detecting unit 70, and upon reception of a command (Step S9), identifies whether the command indicates display of a hint screen or display of a manual (Step S10).

When the received command indicates display of a hint screen or a manual (Step S10/Yes), the screen controlling unit 60 acquires a HTML file of hint screen generated in the hint controlling unit 50 or a HTML file of manual stored in the manual data storing unit 40 (Step S11).

Then the screen controlling unit 60 analyzes layout of the hint screen or manual based on the acquired HTML file of the hint screen or manual, and displays the hint screen or manual on the operation panel 80 (Step S12).

On the other hand, when the command received from the operation detecting unit 70 does not indicate display of hint screen or manual (Step S10/No), the screen controlling unit 60 reads out a screen from the operation data storing unit 30 based on ID of the command received from the operation detecting unit 70 (Step S13). Then the screen controlling unit 60 displays the read out screen on the operation panel 80 (Step S14).

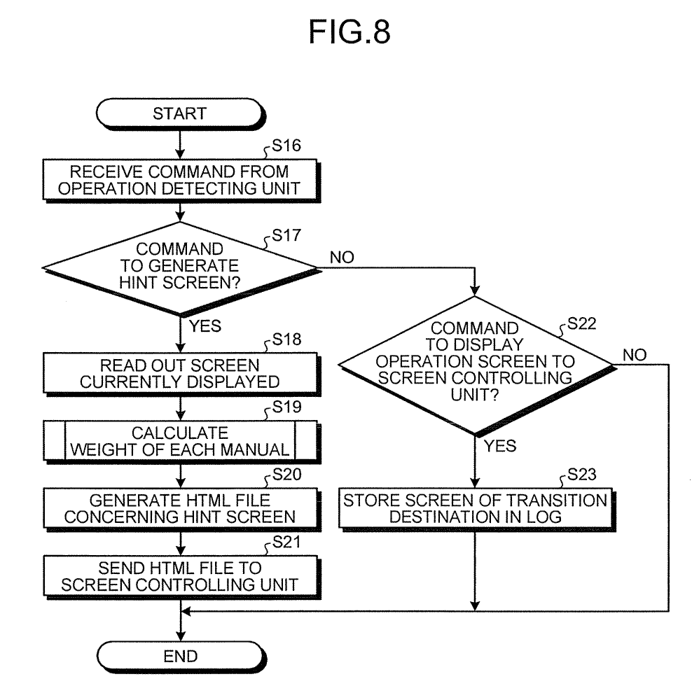

FIG. 8 is a flow chart of a process executed by the hint controlling unit 50 in response to a command sent to each section from the operation detecting unit 70. First, the hint controlling unit 50 waits for a command from the operation detecting unit 70, and upon reception of a command (Step S16) identifies whether the received command indicates generation of a hint screen (Step S17).

When the command from the operation detecting unit 70 indicates generation of a hint screen (Step S17/Yes), the hint controlling unit 50 reads out a currently displayed screen from the log 50a (Step S18).

Next, the manual designating unit 50b designates a plurality of manuals correlated with the screen read out in Step S18 in the operation data storing unit 30. Further, the operation designating unit 50c designates an operation associated with each of the plural manuals designated in the manual designating unit 50b in the manual data storing unit 40. The weighting unit 50d gives weight corresponding to an operation accumulated in the log 50 coinciding with each operation designated by the operation designating unit 50c for each of the plural manuals designated by the manual designating unit 50b (Step S19).

When weight is given to each manual, the hint screen generating unit 50e generates a HTML file of hint screen in which display form showing link of each manual and order of each manual are varied, based on the weight of each manual calculated in Step S19 (Step S20). The hint controlling unit 50 sends the generated HTML file to the screen controlling unit 60 (Step S21).

On the other hand, when the command from the operation detecting unit 70 does not indicate generation of a hint screen (Step S17/No), the hint controlling unit 50 identifies whether the command sent from the operation detecting unit 70 is a command that indicates display of a screen to the screen controlling unit 60 (Step S22). When the command from the operation detecting unit 70 indicates display of a screen to the screen controlling unit 60 (Step S22/Yes), the hint controlling unit 50 stores a screen of transition destination in the log 50a (Step S23).

In Step S22, when the command from the operation detecting unit 70 does not indicate display of a screen to the screen controlling unit 60 (Step S22/No), the hint controlling unit 50 ends the process as it stands.

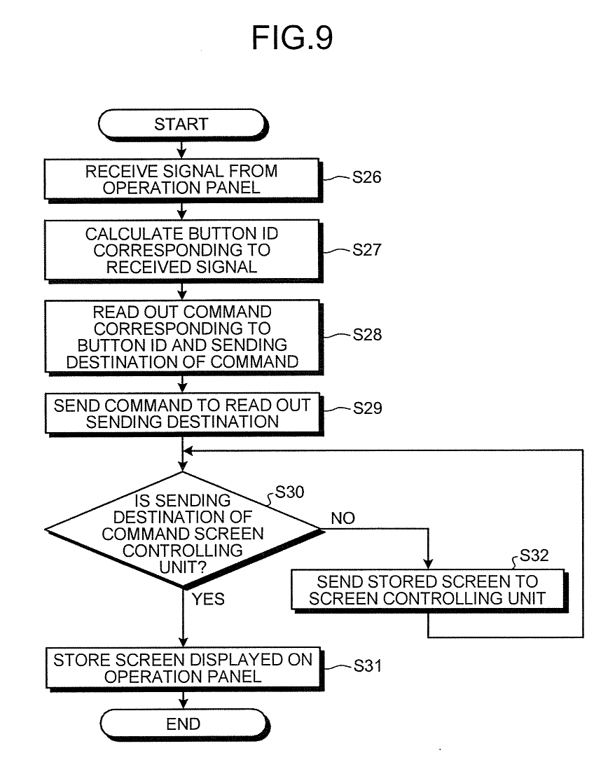

FIG. 9 is a flowchart of a process executed by the operation detecting unit 70 according to a signal from the operation panel 80. First, the operation detecting unit 70 receives from the operation panel 80, input of a signal corresponding to an operation that is made by a user through the operation panel 80 (Step S26).

Upon reception of a signal sent from the operation panel 80, the operation detecting unit 70 determines a button ID corresponding to the received signal based on data concerning screen that is stored in the operation data storing unit 30 using a screen stored in advance (Step S27). Next, the operation detecting unit 70 reads out a command corresponding to the determined button ID and a sending destination thereof from the correspondence table stored in the operation data storing unit 30 (Step S28), and sends the command to the read out sending destination (Step S29).

When the command corresponding to button ID is sent to the sending destination, the operation detecting unit 70 identifies whether the sending destination of the command is the screen controlling unit 60 (Step S30).

When the sending destination of the command is the screen controlling unit 60 (Step S30/Yes), the operation detecting unit 70 stores the screen displayed on the operation panel 80 and ends the process (Step S31).

On the other hand, when the sending destination of the command is not the screen controlling unit 60 (Step S30/No), the operation detecting unit 70 sends a command indicating display of a screen, which is stored in advance, to the screen controlling unit 60 (Step S32).

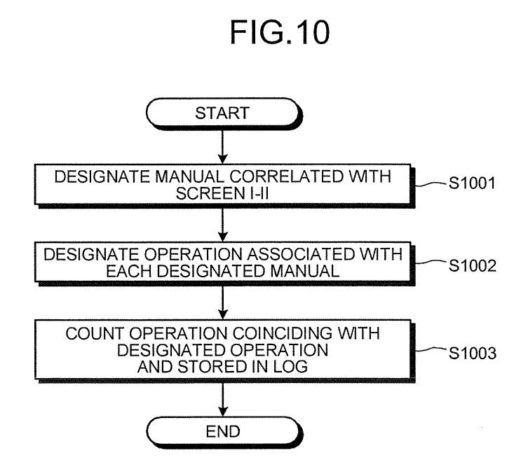

Next, a process of weighting each manual in Step S19 in FIG. 8 will be explained using FIG. 10.

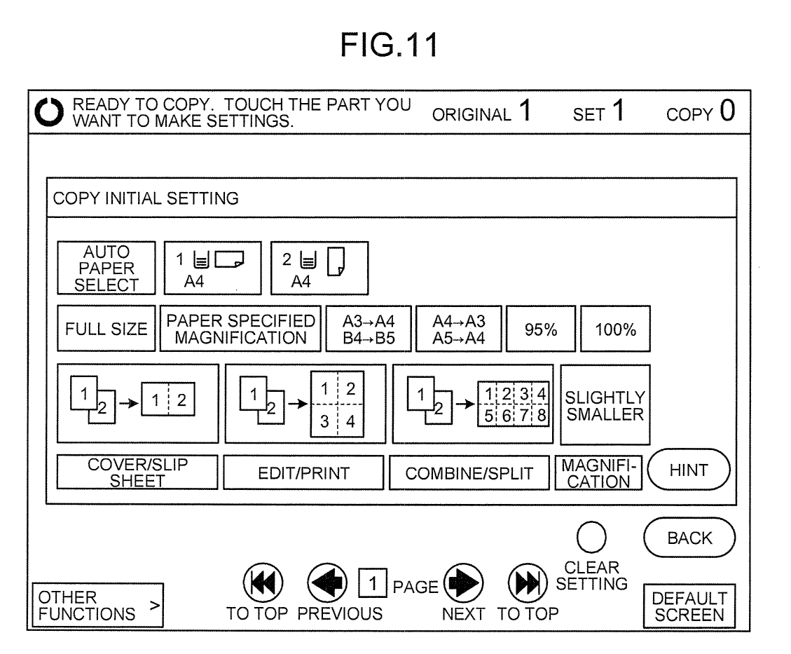

When the screen being displayed on the operation panel 80 (for example, copy initial setting screen (screen I-I I) depicted in FIG. 11 is displayed) is read out from the log 50a, the manual designating unit 50b designates a manual (manual A: copy, manual E: two-sided, manual H: combine, manual K: enlarge/reduce) associated with screen I-II in the operation data storing unit 30 (Step S1001). Then the operation designating unit 50c designates an operation correlated with each manual designated in Step S1001 in the manual data storing unit 40 (Step S1002).

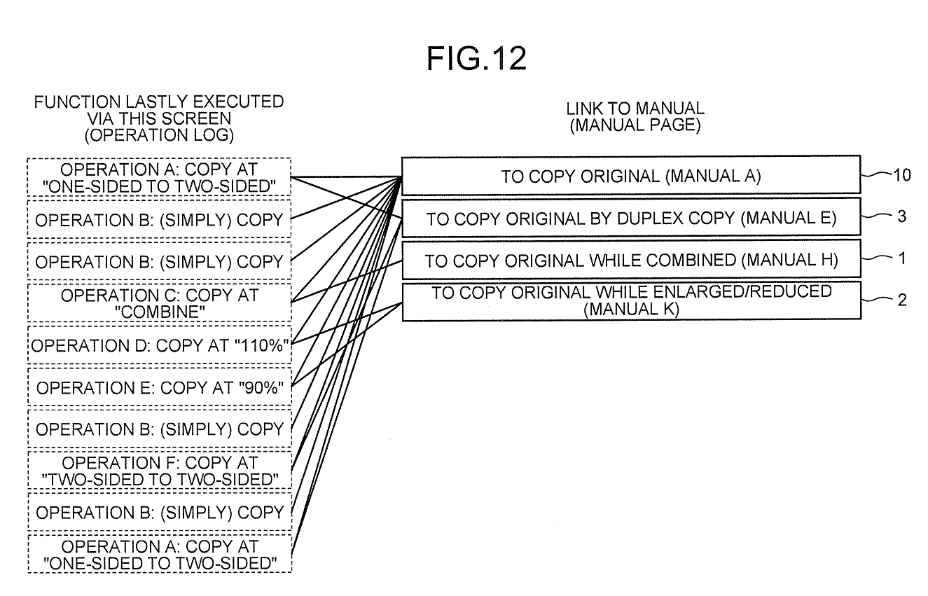

Next, the weighting unit 50d counts a number of operations that are coincidence with the operation designated in Step S1002 and stored in the log 50a as depicted in FIG. 12, and gives weight to each of the plural manuals designated in Step S1001 depending on the number of counted operations (Step S1003). For example, manual A is correlated with six operations from operation A to operation F in the manual data storing unit 40 as depicted in FIG. 4. As the number operations corresponding to manual A, a number from operation A to operation F is counted among the operations stored in the log 50a. At this time, as depicted in FIG. 12, when operation A is stored twice, each operation is counted once. In this manner, when operation of the same kind is stored plural times, such operation is counted plural times.

To be more specific, according to the correspondence between manual and operation depicted in FIG. 4, manual A is linked with every operation that is coincidence with the operations designated in Step S1002, and stored in the log 50a, so that the number of operations linked with manual A is “10”. For other manuals, the number of linked operations is counted in a similar manner. Here, the larger the number of counted operations, the higher the possibility that the manual describes necessary information for the operation executed via the screen I-II. This in turn suggests high necessity of the manual page.

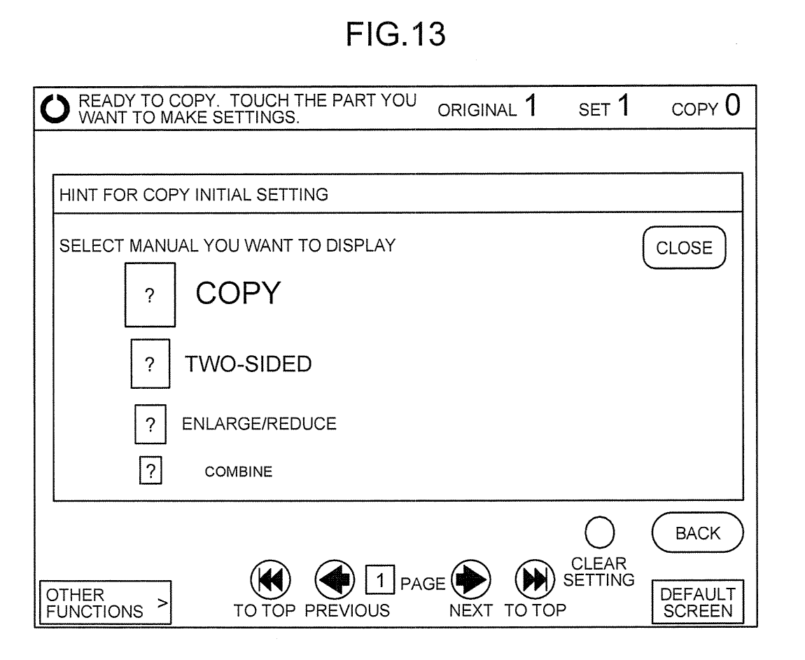

Then the hint screen generating unit 50e generates a HTML file in which display form and order of display showing link to each manual in hint screen I-II correlated with screen I-II are varied, based on the weight of each manual. FIG. 13 is one exemplary hint screen displayed based on weight of each manual calculated in Step S19 of FIG. 8. In the example depicted in FIG. 13, manuals are displayed in the order of weight, and the size of character is varied depending on the weight, so that a user can readily select the manual having high possibility of containing information that the user wants to refer. In the example depicted in FIG. 13, each manual is displayed while character size is varied depending on weight of each manual, however, any other methods that allow display in different display forms of manual such as character color, font, under line, thickness of character, half-tone dot meshing and the like based on the weight are possible without limited to the above example.

Further, in FIG. 12, weight is given to each manual based on the number of operations that are coincidence with operations designated in Step S1002 and stored in the log 50a. However, the weighting unit 50d gives larger weight on the operation executed directly from the screen being displayed (screen in which request for display of hint screen is made) than on the operation executed from screen other than the screen being displayed, among the operations which are coincident with the operations designated by the operation designating unit 50c and stored in the log 50a. Accordingly, the operation actually requested in the displayed screen is more likely to be selected than other operations. Therefore, a hint screen which is more suited for screen transition history can be provided.

Concretely, among the operations designated in Step S1002, by counting the number operations directly executed from screen I-II as “2”, it is possible to provide a hint screen which is more suited for the screen that is currently displayed. That is, the operation executed from the screen (screen I-II-I or screen I-II-II) in the hierarchy lower than that of the currently displayed screen (screen I-II) is more likely to need a manual concerning the operation in the screen which is in lower hierarchy than that of the currently displayed screen.

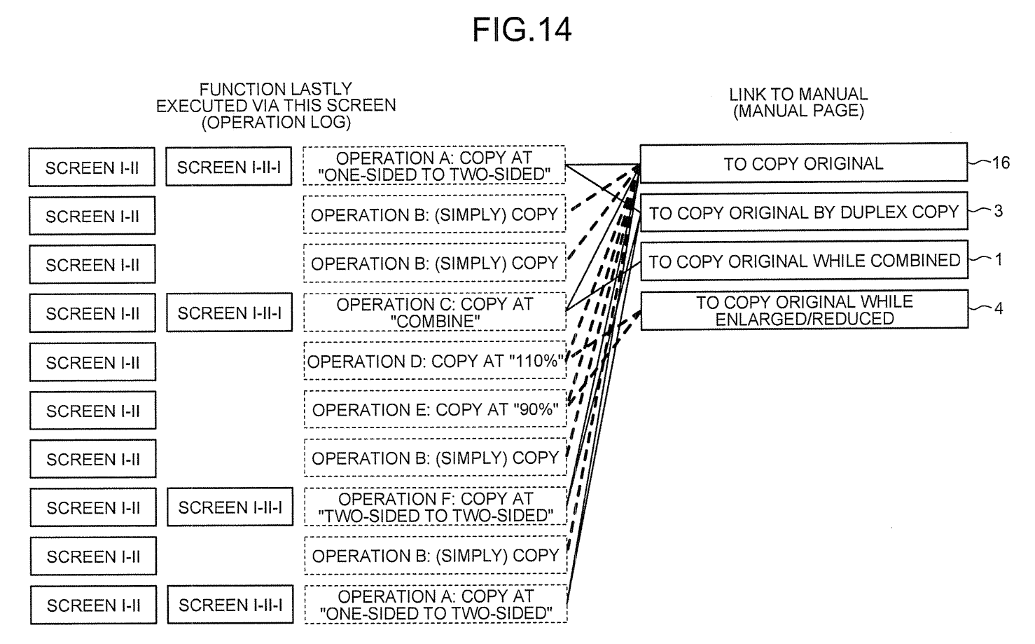

For this reason, as depicted in FIG. 14, among the operations designated in Step S1002, by counting the number of operations executed via screen I-II-I or screen I-II-II as “1”, and counting the number of operations executed from screen I-II as “2”, weight of operation is variably determined depending on the screen being displayed. In FIG. 14, the link between operation executed from screen I-II and each manual is shown by a broken line.

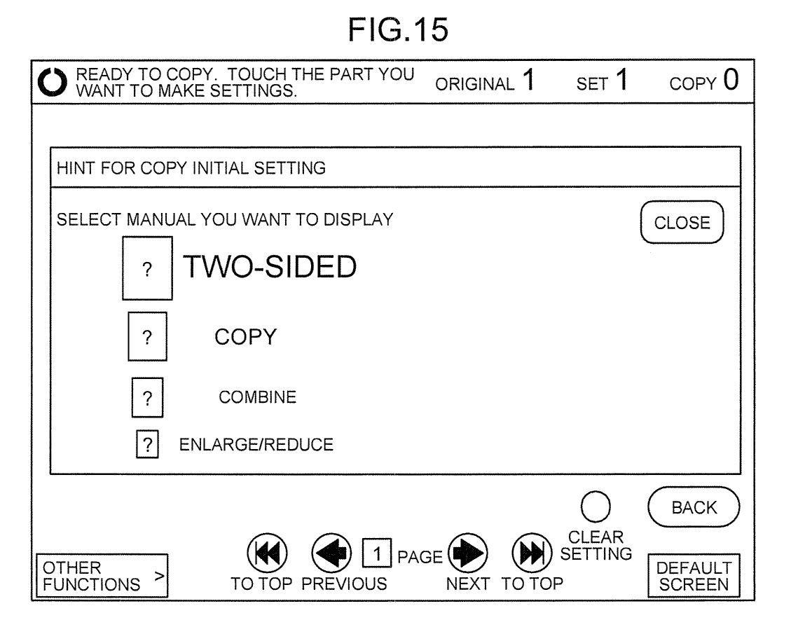

Also among the manuals read in Step S1001, by giving larger weight on manual E which cannot be referred from screen I-II-I or screen I-II-II in lower hierarchy level than screen I-II, it is possible to provide a hint screen that is more suited to the displayed screen. That is, the manual that is referable from the screen in lower hierarchy (screen I-II-I or screen I-II-II) than the currently displayed screen (screen I-II) is more likely to need the manual in the screen in lower hierarchy than the currently displayed screen. As depicted in FIG. 15, by displaying manual E in larger size by giving larger weight, and displaying other manuals in smaller size, it possible to provide a hint screen that is more appropriate to the currently displayed screen.

Further, when a manual is not referred from screen I-II, among the manuals read out in Step S1001, larger weight is given to the manual for which the number of requested operations is large before each manual is referred from screen I-II-I or screen I-II-II in lower hierarchy than screen I-II, or to the manual which is referable only from screen I-II.

For example, before referring the manuals read out in Step S1001 (manual A, manual E, manual H, manual K) in screen I-II-I or in screen I-II-II, a user first makes the screen displayed on the operation panel 80 transit from screen I-II to screen I-II-I or screen I-II-II. Then the user makes screen I-II-I or screen I-II-II display hint screen I-II-I or hint screen I-II-II. Finally, the user selects a necessary manual from manuals displayed in hint screen I-II-I or in hint screen I-II-II. Thus, since the user needs to operate at least three times in the operation panel 80, weight “3” is given to each manual. In the present embodiment, operation number is “3” for any of manual A, manual E, manual H, and manual K, however, when there is a manual that is linked only to hint screen I-II correlated with screen I-II, weight “∞” is given to the manual.

That is, the larger the number of operations required before referring the manual from a screen in lower hierarchy than the currently displayed screen, without referring a manual from the display screen, the more difficult it becomes to reach the manual. Therefore, the larger the number of times the manual is operated, the more likely the manual is required in the displayed screen. For this reason, by giving weight to each manual depending on the number of operations calculated for each manual, it is possible to provide a hint screen which is more appropriate to the currently displayed screen.

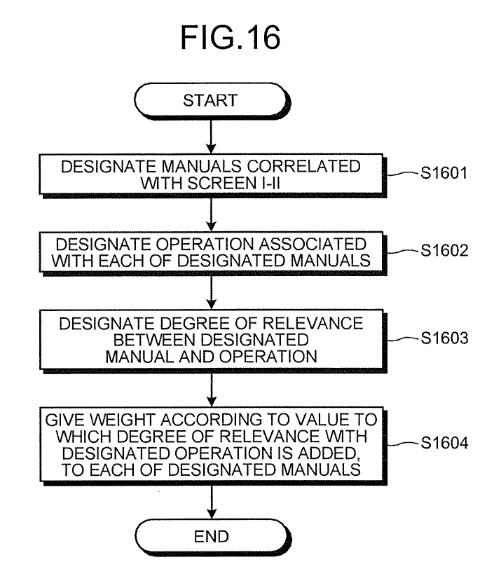

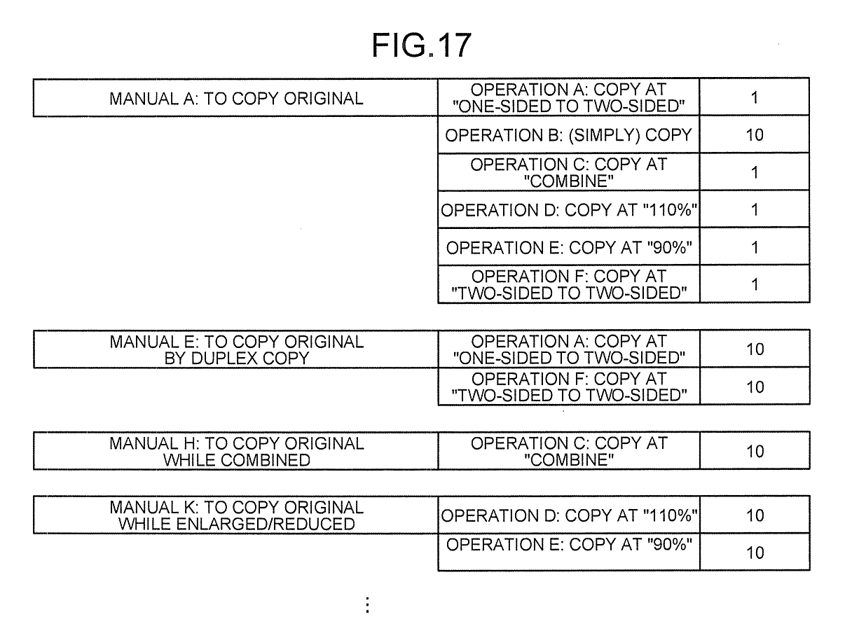

Next, other process of giving weight to each manual in Step S19 in FIG. 8 will be explained by using FIG. 16. In the present embodiment, as depicted in FIG. 17, the manual data storing unit 40 stores each manual and an operation associated with the manual in correspondence with each other, and sets degree of relevance between each manual and operation. Degree of relevance between each manual and operation is arbitrarily set by a user.

When the screen being displayed on the operation panel 80 (for example, copy initial setting screen (screen I-II) depicted in FIG. 11 is displayed) is read out from the log 50a, the manual designating unit 50b designates manuals (manual A: copy, manual E: two-sided, manual H: combine, manual K: enlarge/reduce) correlated with screen I-II in the operation data storing unit 30 (Step S1601). Then the operation designating unit 50c designates in the manual data storing unit 40, operations associated with each of the manuals designated in Step S1601 (Step S1602).

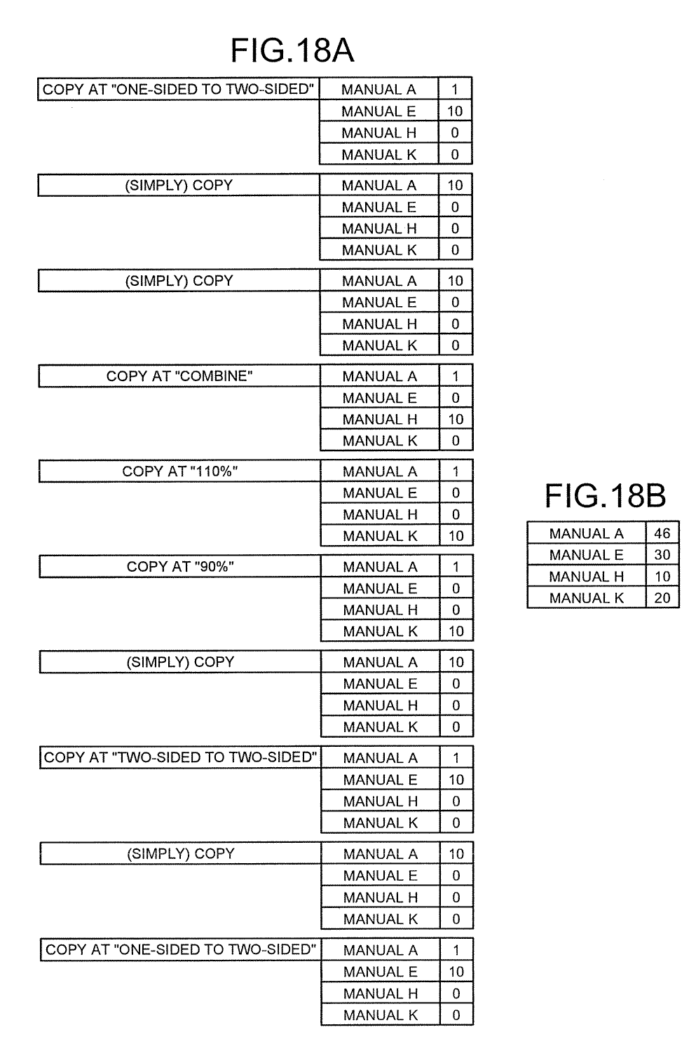

Next, as depicted in FIG. 18A, the weighting unit 50d designates degree of relevance between operations that are coincident with the operations designated in Step S1602 and stored in the log 50a, and each of a plurality of manuals designated in Step S1601 (Step S1603). Next, the weighting unit 50d gives weight depending on a value obtained by adding degree of relevance with designated operation (depicted in FIG. 18B) to each of the plural manuals designated in Step S1601 (Step S1604).

The hint screen generating unit 50e generates a HTML file in which display form and order of display indicating link to each manual in hint screen I-II correlated with screen I-II are varied based on the weight which is sum calculated each manual. In the present embodiment, manuals are displayed in the order of weight, and character size is varied depending on the weight, so that a user can readily select a manual that is more likely to contain information that the user wants to refer.

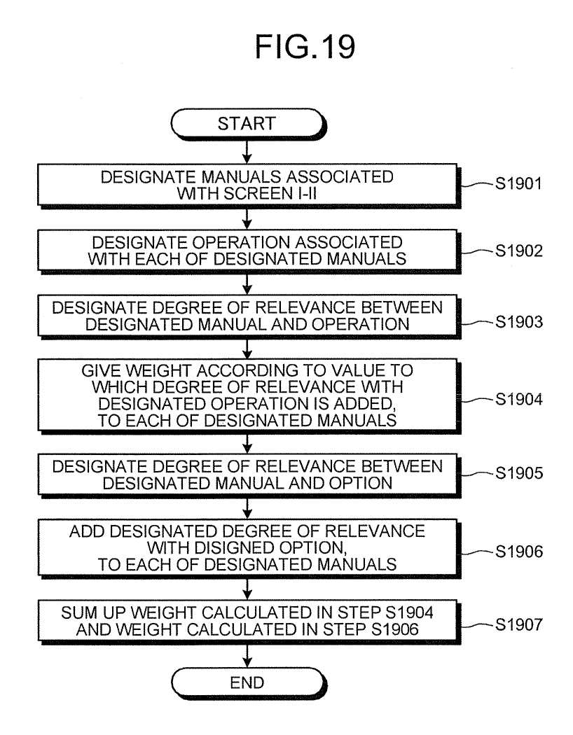

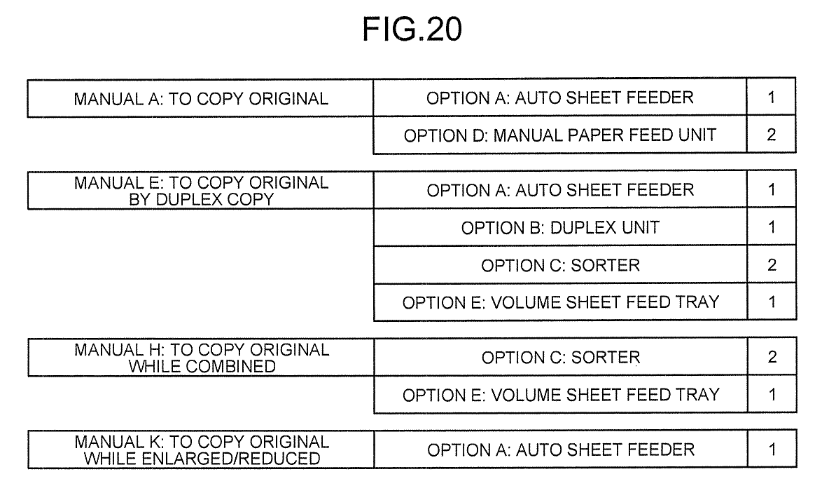

Next, other process of giving weight to each manual in Step S19 in FIG. 8 will be explained by using FIG. 19. Likewise the second embodiment, in the present embodiment, the manual data storing unit 40 stores each manual and operation associated with the manual in correspondence with each other, and sets degree of relevance between each manual and operation. Further, in the present embodiment, as depicted in FIG. 20, the manual data storing unit 40 stores a manual and an option attachable to the image forming apparatus 1 in correlation with each other, and sets degree of relevance between each manual and option. Degree of relevance between manual and option is updated by attachment/detachment of the option to/from the image forming apparatus 1. In the present embodiment, degree of relevance between attached option and manual is set at “2”, and degree of relevance between an option that is not attached, and manual is set at “1”.

Degree of relevance between each manual and option is set based on whether the option is attached to the image forming apparatus 1, however, it may be arbitrarily settable based on the relevance between each manual and option. For example, for the option attachment “two-sided copy unit”, the degree of relevance to manual E is set high, because the relation therebetween is very high. For the option attachment “mass sheet feed tray”, degrees of relevance to manual E and manual H are also set high because relevance therebetween are very high.

When the screen being displayed on the operation panel 80 (for example, copy initial setting screen (screen I-II) depicted in FIG. 11 is displayed) is read out from the log 50a, the manual designating unit 50b designates manuals (manual A: copy, manual E: two-sided, manual H: combine, manual K: enlarge/reduce) associated with screen I-II in the operation data storing unit 30 (Step S1901). Then the operation designating unit 50c designates in the manual data storing unit 40, operations associated with each of the manuals designated in Step S1901 (Step S1902).

Next, as depicted in FIG. 18A, the weighting unit or weighting calculation section 50d designates degree of relevance between operations that are coincident with the operations designated in Step S1902 and stored in the log 50a, and each of a plurality of manuals designated in Step S1901 (Step S1903). Next, the weighting unit 50d gives weight depending on a value obtained by adding relevance with designated operation (depicted in FIG. 18B) to each of the plural manuals designated in Step S1901 (Step S1904).

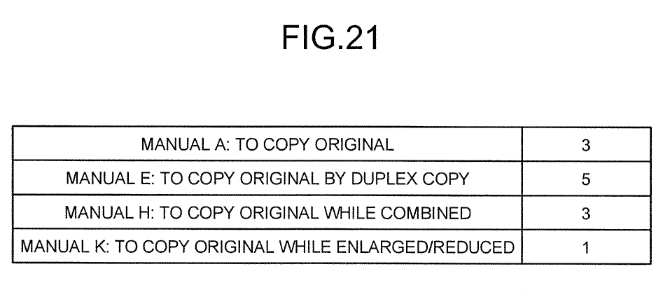

Next, the weighting calculation section or weighting unit 50d designates degree of relevance between each of the plural manuals designated in Step S1901 and an option in the manual data storing unit 40 (Step S1905). Next, degree of relevance of option designated to each of the plural manuals designated in Step S1901 is added to calculate the value depicted in FIG. 21 (Step S1906). For example, as for manual A, degree of relevance “1” between option A and manual A and degree of relevance “2” between option D and manual A are summed to calculate “3”. Similar calculation is executed for other manuals.

Finally, the weighting calculation section 50d sums up weight of each manual calculated in Step S1904 and weight of each manual calculated in Step S1906 (Step S1907). For example, as for manual A, “46” calculated in Step S1904 and “3” calculated in Step S1906 are summed up. Similar calculation is made for other manuals.

The hint screen generating unit 50e generates a HTML file in which display form and order of display indicating link to each manual in hint screen I-II correlated with screen I-II are varied based on the weight which is a sum calculated for each manual. In the present embodiment, weight is given to each manual depending on degree of relevance between option attached/detached to/from the image forming apparatus 1 and the manual, and manuals are displayed in the order of weight, and character size is varied depending on the weight to display, so that a user can readily select a manual that is more likely to contain information that the user wants to refer.

The present embodiment is different from the forgoing embodiments in that in the hint controlling unit 50, a displayed hint screen, and a manual selected in the hint screen are stored together with the screen in the log 50a, and weight is given to each manual depending on the reference history of manuals.

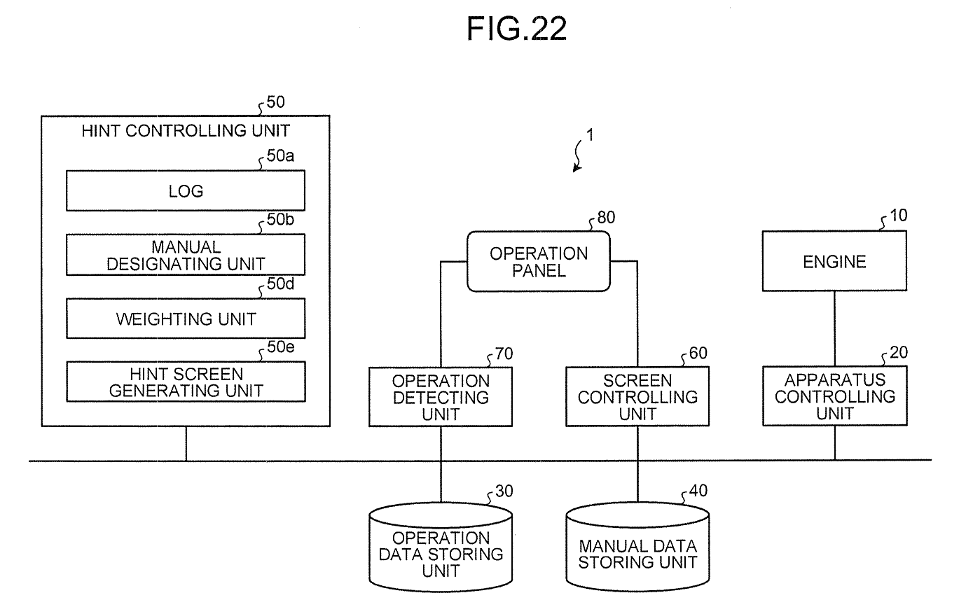

FIG. 22 is a block diagram of a functional configuration of the image forming apparatus 1 according to the present embodiment. The image forming apparatus according to the present embodiment includes the engine 10, the apparatus controlling unit 20, the operation data storing unit 30, the manual data storing unit 40, the hint controlling unit 50, the screen controlling unit 60, the operation detecting unit 70, and the operation panel (touch panel) 80.

The image forming apparatus 1 according to the present embodiment is different from the foregoing embodiments in that the manual data storing unit 40 stores data of each manual without corresponding it with operation associated with the manual. Also it differs from the foregoing embodiments in that the hint controlling unit 50 does not have the operation designating unit 50c. Hereinafter, concrete operation of the hint controlling unit 50 according to the present invention will be explained.

The log 50a according to the present embodiment stores a screen displayed on the operation panel 80 and reference history of screens referred from the screen according to a command from the operation detecting unit 70.

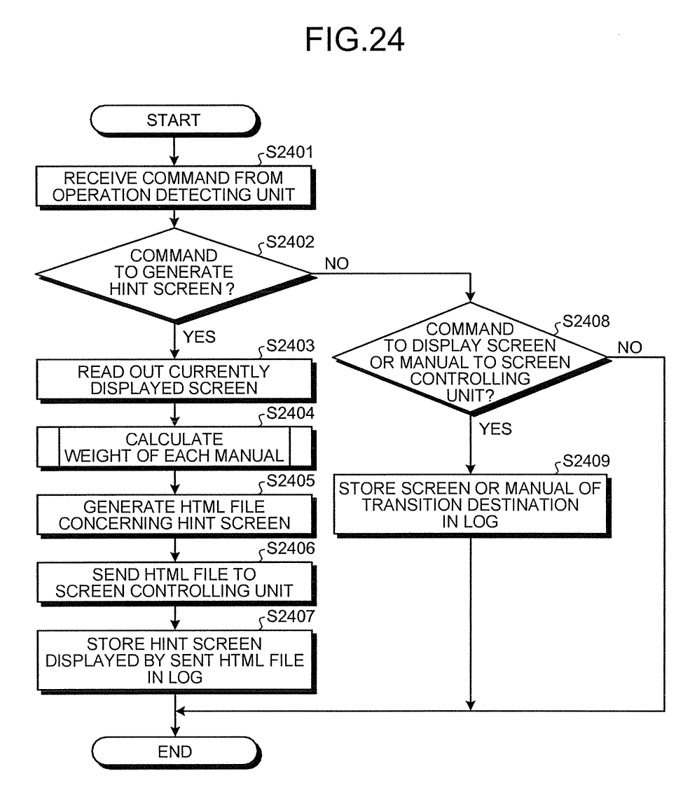

Here, concrete operation of the hint controlling unit 50 according to the present embodiment will be explained by using FIG. 24.

FIG. 24 is a flowchart of a process executed by the hint controlling unit 50 according to a command send to each section from the operation detecting unit 70. First, as the hint controlling unit 50 waiting for a command from the operation detecting unit 70 receives a command (Step S2401), it identifies whether the received command indicates generation of a hint screen (Step S2402).

When the command from the operation detecting unit 70 indicates generation of a hint screen (Step S2402/Yes), the hint controlling unit 50 reads out a currently displayed screen from the log 50a that manages screen transition history (Step S2403).

Then the manual designating unit 50b reads out manuals that are referable from the screen read out in Step S2403 from the operation data storing unit 30. The weighting calculation section 50d gives weight to each manual based on the reference history of each manual stored in the log 50a (Step S2404).

After weight is given to each manual, the hint screen generating unit 50e generates a HTML file of hint screen based on the weight of each manual given in Step S2404 (Step S2405). The generated HTML file is sent to the screen controlling unit 60 (Step S2406). As the HTML file is sent to the screen controlling unit 60, the hint controlling unit 50 stores a hint screen displayed by the sent HTML file in the log 50a (Step S2407).

On the other hand, when the command from the operation detecting unit 70 does not indicate generation of a hint screen (Step S2402/No), the hint controlling unit 50 identifies whether the command sent from the operation detecting unit 70 is a command that indicates display of a screen or manual to the screen controlling unit 60 (Step S2408). When the command from the operation detecting unit 70 indicates display of a screen or a manual to the screen controlling unit 60 (Step S2408/Yes), the hint controlling unit 50 stores a screen or manual of transition destination in the log that stores transition history or the like of screen (Step S2409).

When the command from the operation detecting unit 70 does not indicate display of a screen or manual to the screen controlling unit 60 (Step S2408/No), the hint controlling unit 50 ends the process as it stands.

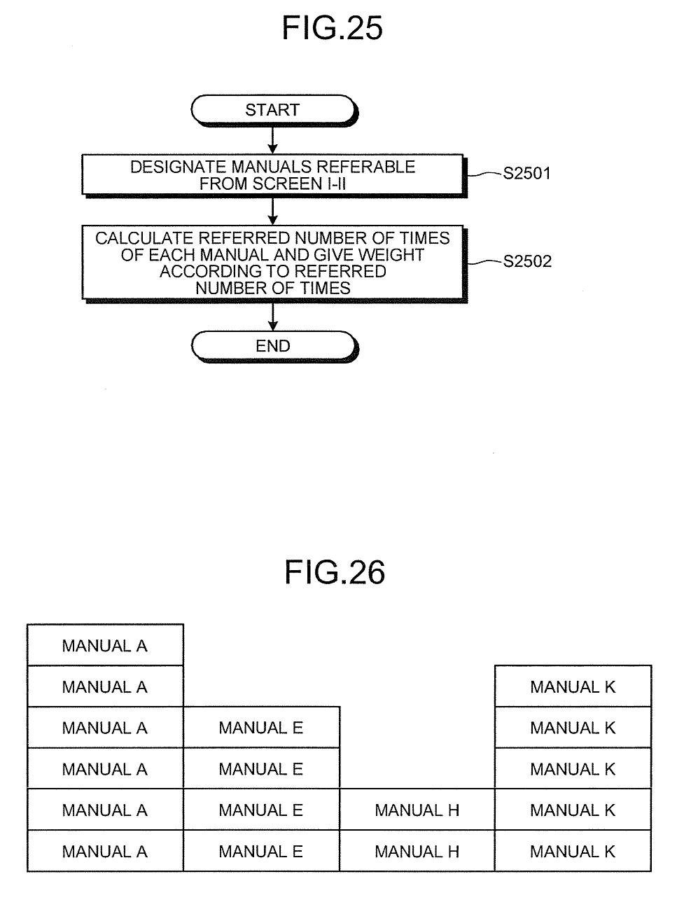

Next, a process of giving weight to each manual in Step S2404 in FIG. 24 will be explained by using FIG. 25.

When the screen being displayed on the operation panel 80 (for example, screen I-II) is read out from the log 50a, the manual designating unit 50b designates manuals (manual A, manual E, manual H, manual K) that are referable from screen I-II from the operation data storing unit 30 (Step S2501). Further, the weighting unit 50d calculates the number of times the manual designated in Step S2501 is referred based on reference history of each manual stored in the log 50a, and gives weight to the manual designated in Step S2501 according to the calculated number of times (Step S2502).

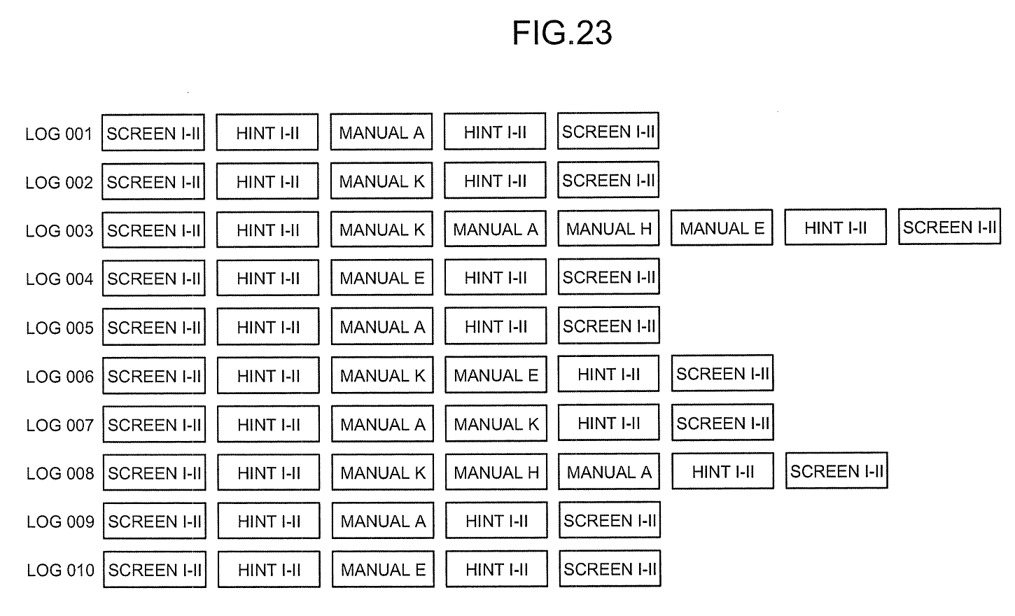

For example, when the log 50a depicted in FIG. 23 is stored, the weighting unit 50d calculates the referred number of times of manual in log 001 to log 010. FIG. 26 is a result of calculation of referred number of times of manual. As depicted in FIG. 25, manual A is referred 6 times, manual E is referred 4 times, manual H is referred 2 times, and manual K is referred 5 times.

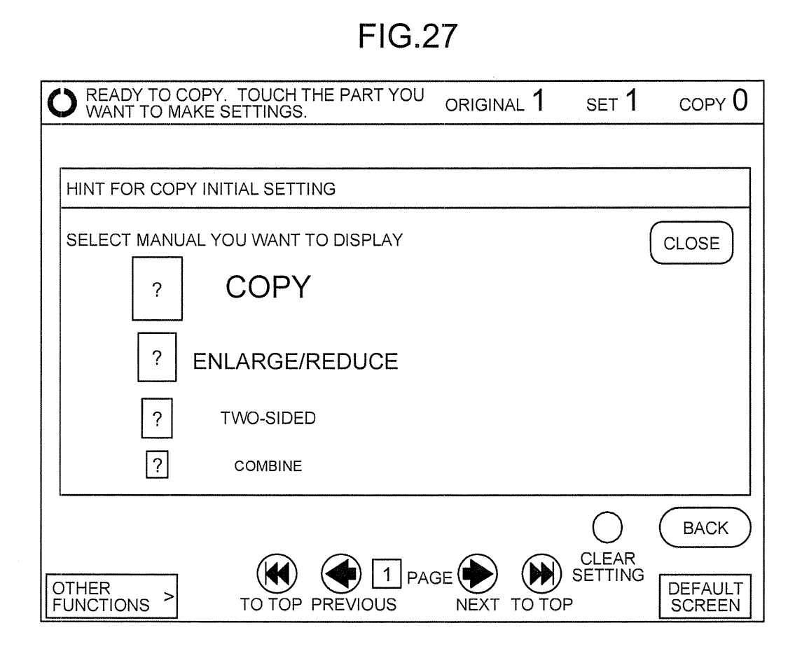

The hint screen generating unit 50e generates a HTML file in which display form and order of display indicating link to each manual in hint screen I-II correlated with screen I-II are varied based on the weight given to each manual. FIG. 27 is one example of hint screen displayed based on the weight of each manual calculated in Step S2404 of FIG. 24. In the example depicted in FIG. 27, manuals are displayed in the order of weight, and character size is varied depending on the weight to display, so that a user can readily select a manual that is more likely to contain information that the user wants to refer.

In the example depicted in FIG. 26, a total sum of referred history of each manual is regarded as referred number of times, however, it is also possible to calculate referred number of times of each manual referred lastly in each log, and give weight to each manual based on the referred number of time. For example, in log 001 to log 010 depicted in FIG. 23, for manual A referred lastly in log 001, manual K referred lastly in log 002, manual E referred lastly in log 004, manual A referred lastly in log 005, manual E referred lastly in log 006, manual K referred lastly in log 007, manual A referred lastly in log 008, manual A referred lastly in log 009, and manual E referred lastly in log 010, referred number of times is calculated for each manual. Since log 003 refers all the manuals that are stored while liked with hint screen I-II, and information that is required by a user may not be eventually included, it is not included in referred number of times.

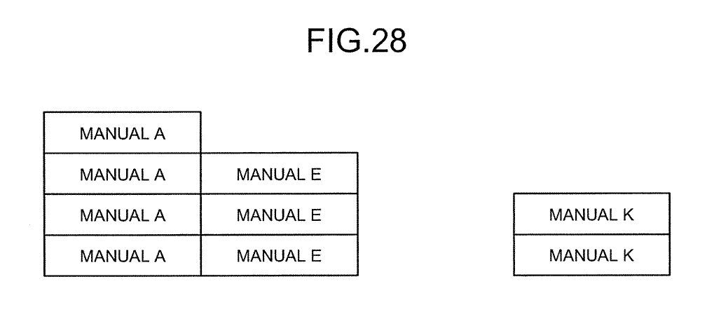

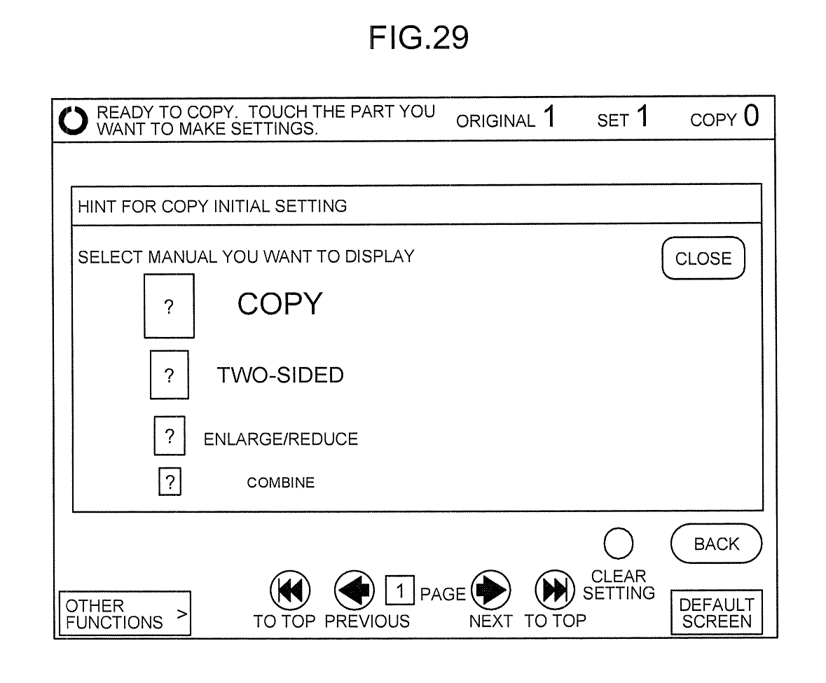

FIG. 28 is a diagram of referred number of times of each manual. FIG. 29 is one example of a hint screen displayed according to weight of each manual calculated based on the referred number of times of each manual depicted in FIG. 28. In the example depicted in FIG. 29, manuals are displayed in the order of weight, and character size is varied depending on the weight, so that a user can readily select a manual that is more likely to contain information that the user wants to refer.

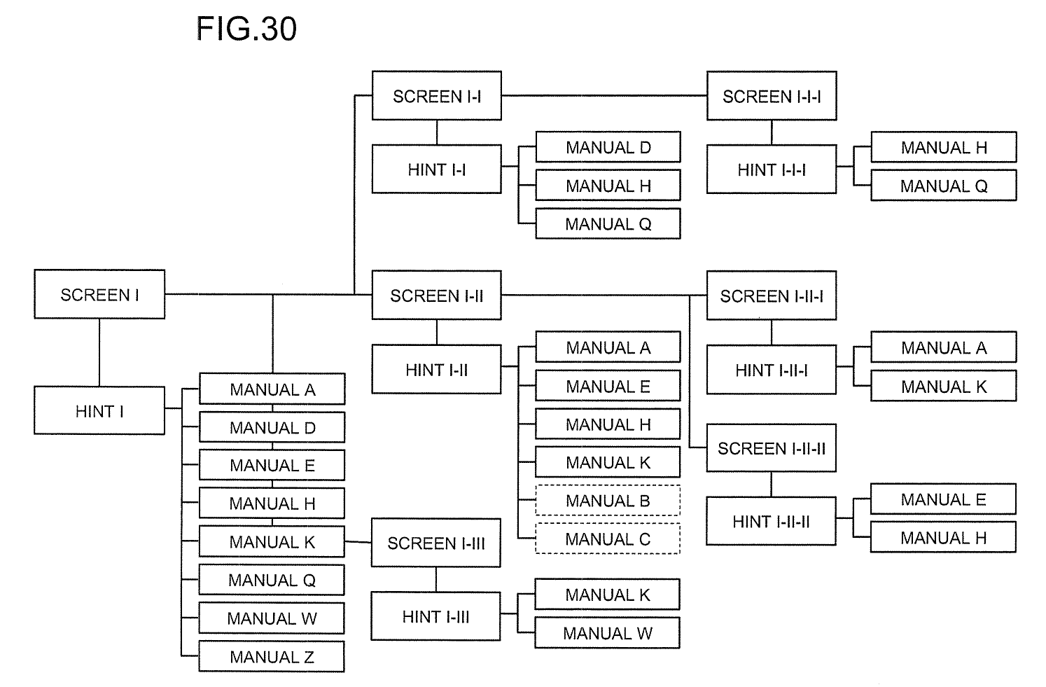

Next, explanation will be given for the process of giving weight to each manual when a manual of new function is added as a result of addition of the new function to the image forming apparatus 1. FIG. 30 is a view of a tree structure in which manual B: staple, and manual C: punch are newly added to manual A, manual E, manual H, and manual K linked to hint screen I-II as depicted in FIG. 2.

When a new manual is added, such a manual has no history of reference. If weight is given to each manual based on the referred number of times of the each manual, weight of the new manual is small, and operation of reaching the new manual becomes difficult. This may hinder effective use of the new function.

In light of this, in the present embodiment, by giving weight to the newly added manual independently, and giving weight to the existent manuals in the same manner as described above, it is possible to prevent the weight of new manual from being small. In the following, an example of calculation method of weight to be given to a new manual will be explained.

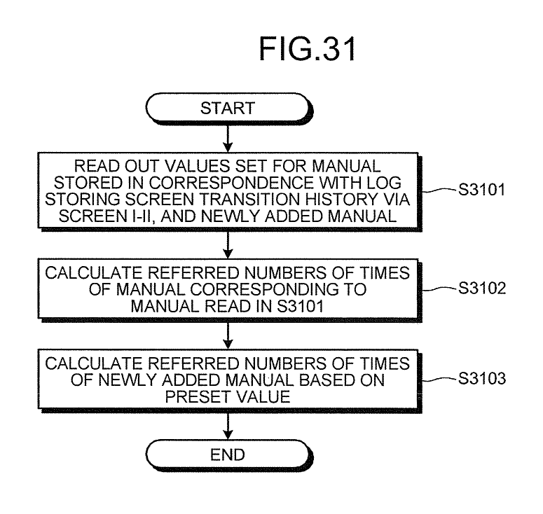

First, with reference to FIG. 31, a process of giving weight to each manual in Step S2404 of FIG. 24 will be explained. In the present embodiment, as to newly added manual B and manual C, values which are worth referred numbers of times of existent manuals are set in correlation with manual B and manual C contained in the tree structure depicted in FIG. 30, and are read out in Step S2404 of FIG. 24 together with the manuals.

When a screen being displayed on the operation panel 80 (for example, screen I-II) is read out from the log 50a, the manual designating unit 50b reads out a manual stored in correspondence with a screen transition history via screen I-II and a value set for the newly added manual (Step S3101). In the present embodiment, “10” for newly added manual B, and “6” for newly added manual C are preset. Next, the weighting unit 50d calculates referred numbers of times of the manuals read out in Step S3101, and gives weights according to the referred numbers of times to the manuals (Step S3102).

For example, when the log 50a depicted in FIG. 23 is stored, the weighting unit 50d calculates a referred number of times of each manual in log 001 to log 010. FIG. 26 is a result of calculation of referred number of times of each manual. As depicted in FIG. 26, manual A is referred 6 times, manual E is referred 4 times, manual H is referred 2 times, manual K is referred 5 times, manual B is referred 0 time, and manual C is referred 0 time.

Since manual B and manual C are newly added manuals, they have not been referred. Therefore, the weighting unit 50d reduces the values “10” and “6” preset for manual B and manual C to halves, and gives “5” as a referred number of times to manual B, and gives “3” as a referred number of times to manual C (Step S3103). In the present embodiment, preset values for manual B and manual C are corrected so that average of referred numbers of times of manual A, manual E, manual H, and manual K is substantially equal to average of referred numbers of times given to manual B and manual C in Step S2903, and thus referred numbers of times of manual B and manual C are calculated.

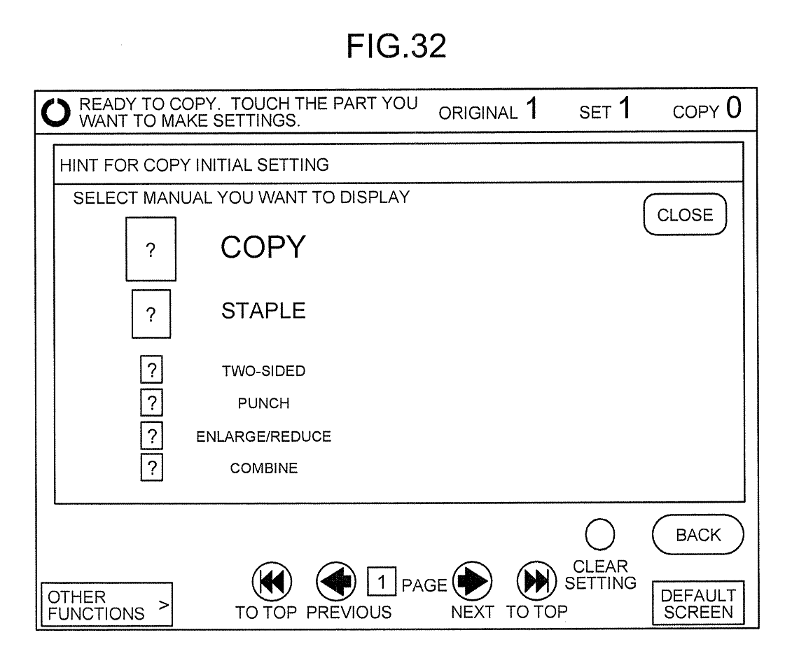

The hint screen generating unit 50e generates a HTML file in which display form and order of display indicating link to each manual referable from screen I-II based on weight realized by calculated referred number of times of each manual. FIG. 32 is an example of hint screen displayed based on the weight of each manual given weight in Step S2404 of FIG. 24. In the example depicted in FIG. 32, manuals are displayed in the order of weight, and character size is varied depending on the weight, so that a user can readily select a manual that is more likely to contain information that the user wants to refer. Further, by giving weight to newly added manuals independently, and giving weights to an existence manual based on referred numbers of times of the manual, it is possible to prevent weight of the newly added manual from being small, and to facilitate reference of the newly added manual.

The image forming apparatus 1 according to the first to the forth embodiments is configured by the following hardware.

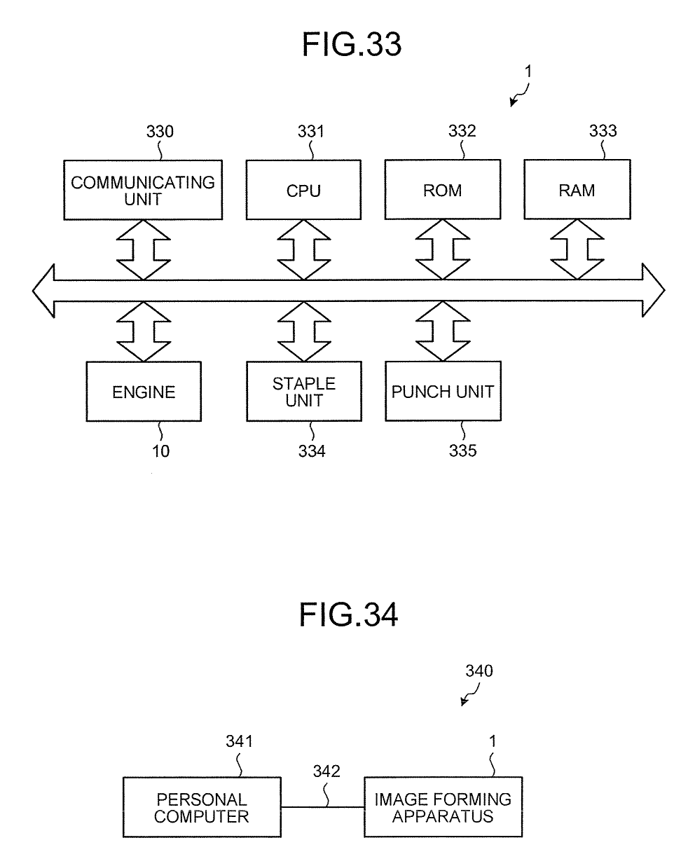

FIG. 33 is a block diagram of a schematic configuration of the image forming apparatus 1. As depicted in FIG. 33, the image forming apparatus 1 includes a communicating unit 330 that executes data communication, a CPU 331 that controls the entire image forming apparatus 1, a ROM 332 that stores various control programs for operation of the CPU 331, a RAM 333 that temporarily stores print data of print job and print condition data input, for example, from work area of various control programs and personal computers, the engine 10 for printing print data on transfer paper, a staple unit 334 for stapling paper on which print data is printed, and a punch unit 335 for punching holes in the transfer paper on which print data is printed. That is, the image forming apparatus 1 has a two-sided copying function, a punching function, a stapling function and the like.

The communicating unit 330 is provided for executing data communication with external devices, and executes data communication with a personal computer, for example.

The CPU 331 is a central control unit that controls the entire operation of the apparatus according to various control programs stored in the ROM 332. The CPU 331 to which the communicating unit 330, the ROM 332, the RAM 333, the engine 10, the staple unit 334, and the punch unit 335 are connected, controls data communication, printer operation and the like.

The ROM 332 stores, for example, various control programs for operation of the CPU 331 and parameters for use in the process thereof. The RAM 333 has a work memory that stores, for example, designated control program, process result and received print data.

The engine 10 includes an electrophotographic printer engine that prints print data onto transfer paper. As a printing method of the image forming apparatus 1, an ink-jet method, a dye sublimation thermal transfer method, a silver halide photography method, a direct thermosensitive recording method, a melting thermal wax transfer method and the like various methods as well as the electrophotographic method can be employed.

Although the image forming apparatus 1 is applied in the first to the forth embodiments, the application is not limited to this. For example, operation effects similar to the various operation effects can also be realized by connecting the image forming apparatus 1 to a personal computer, installing a predetermined program to a storage device such as Hard Disk Drive (HDD) of the personal computer, and causing a Central Processing Unit (CPU) of the personal computer to operate according to the program.

FIG. 34 is a block diagram of a schematic configuration example of a print system 340 according to a fifth embodiment of the present invention. The print system 340 depicted in FIG. 34 is constructed by a personal computer 341 that sends out print data and print job containing print condition for printing the print data, and the image forming apparatus 1 that prints the print data connected via a cable 342.

The personal computer 341 sends print data corresponding a created document, and print condition data (sheet orientation, two-sided, combine, book, staple, punch, enlarge/reduce and the like) set for printing the document as print job to the image forming apparatus 1.

The image forming apparatus 1 prints out print data according to the print job sent from the personal computer 341. Concretely, the image forming apparatus 1 prints out the print data contained in the print job on a medium such as paper according to the print condition data (sheet orientation, two-sided, combine, book, staple, punch, enlarge/reduce and the like) contained in the print job.

In the following, concrete structures of the personal computer 341 and the image forming apparatus 1 will be sequentially explained.

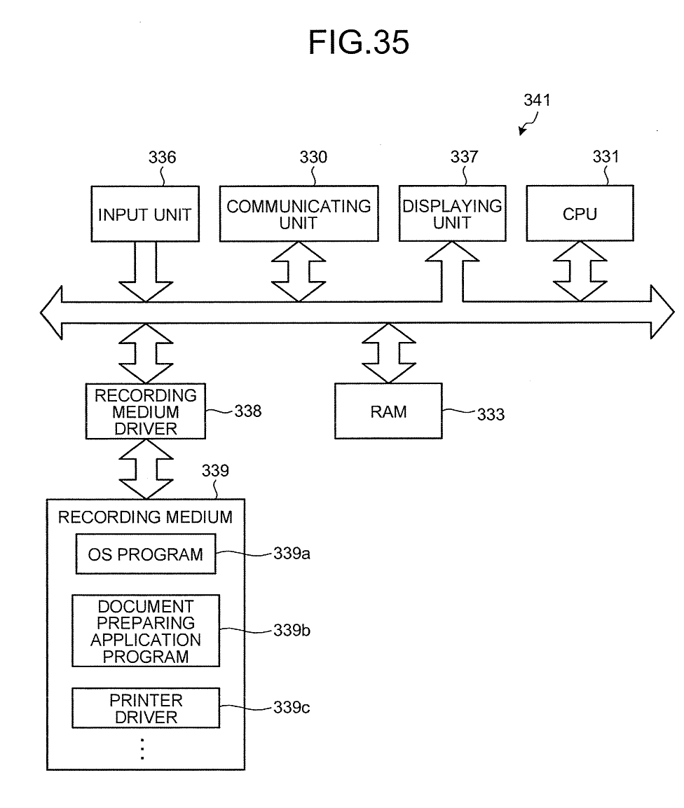

FIG. 35 is a block diagram of a schematic configuration of the personal computer 341. In FIG. 35, the personal computer 341 includes an input unit 336 for inputting data, a displaying unit 337, the communicating unit 330 for conducting data communication, the CPU 331 for controlling the entire operation of the apparatus, the RAM 333 used as a work area of the CPU 331, a recording medium driving device 338 for reading/writing data of recording medium, and a recording medium 339 that stores various programs for operation of the CPU 331.

The input unit 336 includes a keyboard having cursor keys, number entry keys and various function keys, or a mouse or slice pad provided, for example, for selection of key on the display screen of the displaying unit 337. The input unit 336 constitutes a user interface through which an operator gives an operation instruction to the CPU 331 or inputs data.

The displaying unit 337 includes CRT, LCD or the like, and makes display according to display data input from the CPU 331. The communicating unit 330 is provided for data communication with the external devices, and executes data communication with the image forming apparatus 1 or the like, for example, via the cable 342.

The CPU 331 is a central control unit that controls the entire operation of the apparatus according to the program stored in the recording medium 339. The CPU 331, the input unit 336, the displaying unit 337, the communicating unit 330, the RAM 333, and the recording medium driving device 338 are connected to the CPU 331. The CPU 331 controls data communication, readout of application program by access of memory, reading/writing of various data, data/command input, display and the like. The CPU 331 sends print data and print condition data of the print data input from the input unit 336 as print job to the image forming apparatus 1 via the communicating unit 330.

The RAM 333 has a work memory for storing a designated program, input instruction, input data, process result and the like, and a display memory that temporarily stores display data to be displayed in display screen of the displaying unit 337.

The recording medium 339 stores various programs and data such as an OS program 339a which is executable by the CPU 331 (for example, WINDOWS (trademark)), a document preparing application program 339b, a printer driver 339c correspond to the image forming apparatus 1 and the like. The recording medium 339 includes, for example, optical/magnetic/electric recording medium such us flexible disc, hard disc, CD-ROM, DVD-ROM, MO, PC card or the like. The above various programs are stored in the recording medium 339 in such a data form that is readable by the CPU 331. The various programs may be stored in the recording medium in advance, or may be stored in the recording medium after being downloaded via communication line. The various programs can be delivered via communication line.

Explanation of schematic configuration of the image forming apparatus 1 will be omitted here because it is as same as the configuration depicted in FIG. 33.

Next, the printer driver 339c of the personal computer 341 will be explained. The printer driver 339c is a software program designed so that a particular program can be operated, without being bothered with other program and with hardware and internal “language” of the image forming apparatus 1, and is provided for controlling the image forming apparatus 1 and for executing process of output data and the like.

The CPU 331 of the personal computer 341 executes generation and display of a preview image based on print data and print condition data of the print data input from the input unit 336, according to the printer driver 339c, transfer of print data prepared in the document preparing application program 339b to the image forming apparatus 1, and the like.

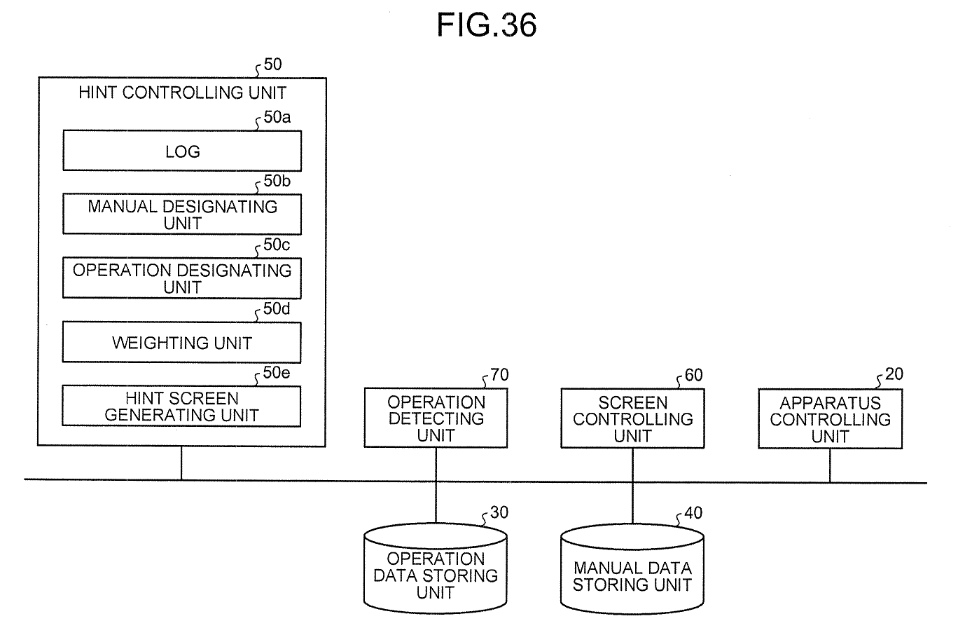

The personal computer 341 includes the apparatus controlling unit 20, the operation data storing unit 30, the manual data storing unit 40, the hint controlling unit 50, the screen controlling unit 60, and the operation detecting unit 70 as depicted in FIG. 36, by the CPU 331 operating according to the printer driver 339c.

In this manner, by the CPU 331 operating according to the printer driver 339c, the personal computer 341 has a system configuration which is equivalent to that of the image forming apparatus 1 depicted in FIG. 1, and can offer equivalent operation effect as the various operation effect as described in the first to the fourth embodiments.

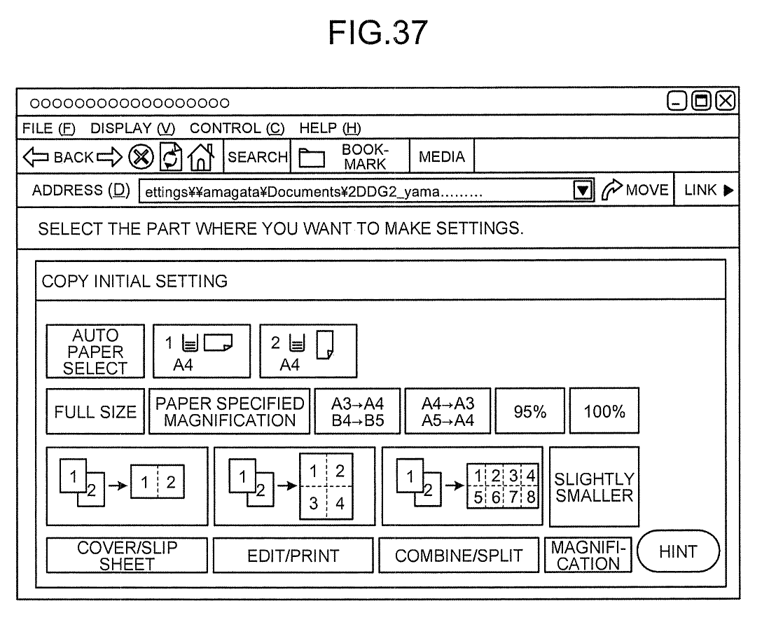

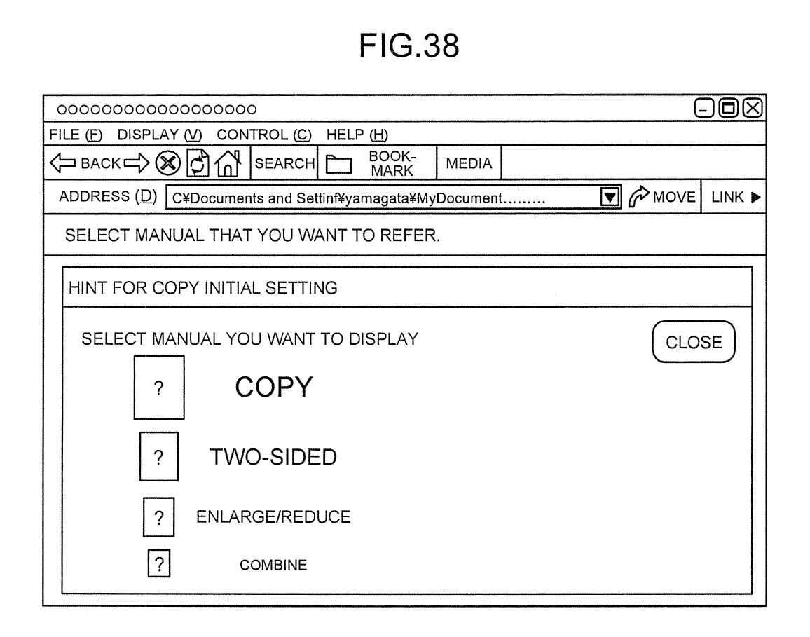

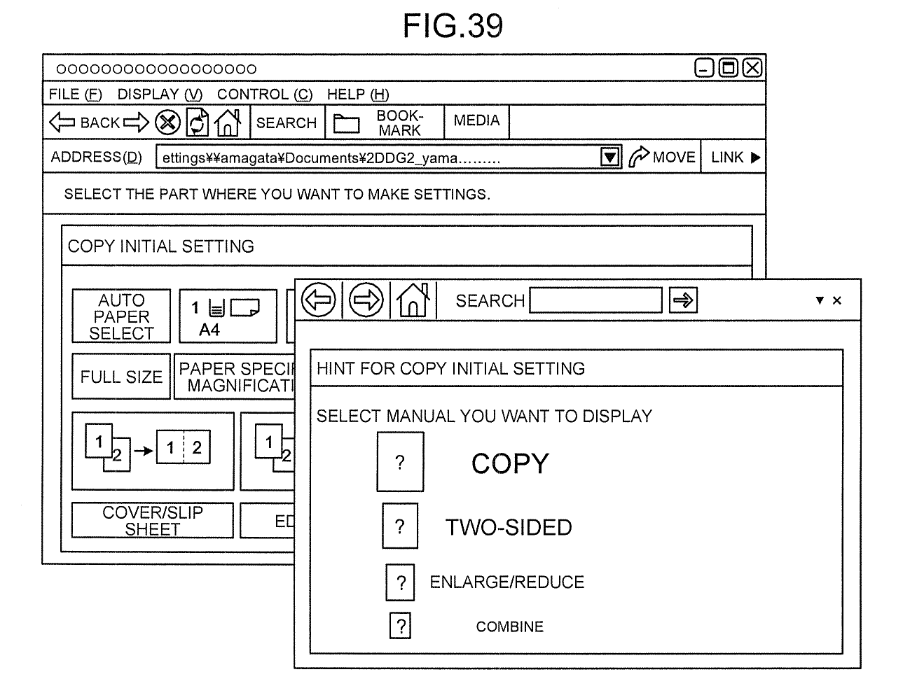

FIG. 37 is a front view of an example of a display screen by the printer driver 339c. The screen depicted in FIG. 37 is a screen displayed when copying function possessed by the image forming apparatus is used. The screen depicted in FIG. 37 is a screen in which copy initial setting is made, and is a screen corresponds to screen I-II of the first to the fourth embodiments. FIG. 38 is a screen in which hint screen I-II is displayed from screen I-II displayed in FIG. 37. Hint screen I-II depicted in FIG. 38 may be displayed as a popup screen of screen I-II depicted in FIG. 37, as depicted in FIG. 39.

Although the invention made by the present inventor is described concretely based on exemplary embodiments in the above, it goes without saying that the present invention is not limited to the above, but may be changed in various ways without departing from the scope of the invention.

In the present invention, when a request to display a hint screen is made from a displayed operation screen, display form and order of each manual showing links to manuals that are referable from the hint screen are displayed and sorted based on weighting of each manual. Therefore, a user is allowed to readily select a manual that is likely to contain the information that the user want to refer.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. An image forming apparatus comprising:
an operation data storing unit that stores relation between a screen displayed on a displaying unit and a plurality of manuals referable from the screen displayed on the displaying unit;
a manual data storing unit that stores relation between the manual and operation of the image forming apparatus;
an accumulating unit that, when a plurality of screens are displayed sequentially on the displaying unit according to an instruction from a user, and a predetermined operation is executed by the image forming apparatus, accumulates the plurality of the displayed screens in correspondence with the executed operation;
a display instruction receiving unit that receives display instruction of the manual from the user;
a manual designating unit that, when the display instruction receiving unit receives the display instruction from the user, designates the plurality of manuals correlated with the screen displayed on the displaying unit in accordance with the relation stored in the operation data storing unit;
an operation designating unit that designates the operation associated with each of the plural manuals designated by the manual designating unit in accordance with the relation stored in the manual data storing unit;
a weighting unit that gives weight to each of the plural manuals designated by the manual designating unit, according to an operation that corresponds to each operation designated by the operation designating unit and is accumulated in the accumulating unit; and
a hint screen generating unit that generates a hint screen in which display of link to each of the plural manuals is varied based on the weight given by the weighting unit.

2. The image forming apparatus according to claim 1, wherein the weighting unit counts a number of the operation that corresponds to each operation designated by the operation designating unit and is accumulated in the accumulating unit, and gives weight to each of the plural manuals designated by the manual designating unit according to the counted number of the operation.

3. The image forming apparatus according to claim 1, wherein the operation data storing unit stores the screens in an order in which the screens are displayed on the displaying unit, and the weighting unit gives smaller weight to the manual referable from the screen displayed in a predetermined order, than to the manual referable only from the screen displayed in the order previous to the predetermined order.

4. The image forming apparatus according to claim 1, wherein the weighting unit gives larger weight on an operation that is executed directly from a currently displayed screen among the operations that correspond to each operation designated by the operation designating unit and are accumulated in the accumulating unit, than other operations executed from a screen other than the currently displayed screen.

5. The image forming apparatus according to claim 1, wherein
the manual data storing unit further stores degree of relevance between the manual and the operation associated with the manual; and
the weighting unit designates in the manual data storing unit, degree of relevance between the operation corresponding to each operation designated by the operation designating unit and accumulated in the accumulating unit, and each of the plural manuals designated by the manual designating unit, and gives weight according to a value to which the degree of relevance with the designated operation is added, to each of the plural manuals designated by the manual designating unit.

6. The image forming apparatus according to claim 1, wherein
the manual data storing unit further stores degree of relevance between the manual and an option operatively attached to the image forming apparatus, and
the weighting unit designates in the manual data storing unit, the degree of relevance between each of the plural manuals designated by the manual designating unit and the option, and further gives weight corresponding to a value in which the degree of relevance with the option is added to each of the plural manuals designated by the manual designating unit.

7. The image forming apparatus according to claim 1, wherein the hint screen generating unit varies at least either one of display form and order of display that represents link to each of the manuals based on weighting by the weighting unit.

8. An image forming apparatus comprising:
an operation data storing unit that stores relation between a screen displayed on a displaying unit and a plurality of manuals referable from the screen displayed on the displaying unit;
an accumulating unit that, when a screen is displayed on the displaying unit according to an instruction from a user, and a manual is referred, accumulates the displayed screen in correspondence with the referred manual;
a display instruction receiving unit that receives display instruction of the manual from the user;
a manual designating unit that, when the display instruction receiving unit receives the display instruction from the user, designates the plurality of manuals correlated with the screen displayed on the displaying unit in accordance with the relation stored in the operation data storing unit;
a weighting unit that gives weight to each of the plural manuals designated by the manual designating unit, according to the number of times that the plural manuals designated by the manual designating unit are referred in the accumulating unit; and
a hint screen generating unit that generates a hint screen in which display of link to each of the plural manuals is varied based on the weight given by the weighting unit.

9. The image forming apparatus according to claim 8, wherein the weighting unit gives weight according to a number of times lastly referred from the screen stored in the accumulating unit, to the plural manuals designated by the manual designating unit.

10. The image forming apparatus according to claim 8, wherein the weighting unit gives weight according to a number of times referred from the screen that is not corresponded to any of referable manuals among the screens stored in the accumulating unit, to the plural manuals designated by the manual designating unit.

11. The image forming apparatus according to claim 8, wherein
the operation data storing unit further stores a referred number of times preset for a newly added manual, and
the weighting unit gives weight according to the referred number of times stored in the operation data storing unit, to the newly added manual among the plural manuals designated by the manual designating unit in accordance with the relation stored in the operation data storing unit.

12. The image forming apparatus according to claim 8, wherein the hint screen generating unit varies at least either one of display form and order of display that represents link to each of the manuals based on weighting by the weighting unit.
